(19) United States
(12) Patent Application Publication
(10) Pub. No.: US 2023/0165405 A1
(43) Pub. Date: Jun. 1, 2023

(54) METHODS AND APPARATUS FOR PRESENTING SAFETY-BASED TEMPERATURE STATUS NOTIFICATIONS FOR GRILLS

(71) Applicant: Weber-Stephen Products LLC, Palatine, IL (US)

(72) Inventors: Kevin James Glennon, Hoffman Estates, IL (US); William Alexander Mecker, Kildeer, IL (US)

(21) Appl. No.: 17/973,255

(22) Filed: Oct. 25, 2022

Related U.S. Application Data
(60) Provisional application No. 63/284,488, filed on Nov. 30, 2021.

(51) Int. Cl. A47J 37/07

(52) U.S. Cl. CPC A47J 37/0786; A47J 37/0709

(57) ABSTRACT

Example methods and apparatus for presenting safety-based temperature status notifications for grills are disclosed. An example grill includes a controller to determine whether a condition indicative of a safety-based temperature status of the grill is satisfied. In response to determining that the condition is satisfied, the controller is to instruct a lighting module or a user interface of the grill to present a notification indicating the safety-based temperature status.

### RELATED APPLICATIONS

This application claims priority to U.S. Provisional Patent Application No. 63/284,488, filed Nov. 30, 2021. The entirety of U.S. Provisional Patent Application No. 63/284,488 is hereby incorporated by reference herein.

### FIELD OF THE DISCLOSURE

This disclosure relates generally to the presentation of notifications for grills and, more specifically, to methods and apparatus for presenting safety-based temperature status notifications for grills.

### BACKGROUND

Some known grills are equipped with one or more electrically-powered component(s) including, for example, a controller, a user interface, a lighting module, and/or one or more sensor(s) or transducer(s). In some such known grills, one or more of the aforementioned electrically-powered component(s) may be configured to present a notification to the user of the grill indicating whether or not the grill is powered on. For example, a user of the grill may discern that the grill is powered on based on an illumination of a lighting module of the grill. Conversely, the user of the grill may discern that the grill is powered off based on an absence of the illumination of the lighting module of the grill. As another example, the user of the grill may discern that the grill is powered on based on a message or an alert presented textually, graphically, and/or audibly via a user interface of the grill, whereas an absence of such a message or an alert may instead inform the user that the grill is powered off.

With reference to conventional grill implementations such as those described above, while the presentation of the notification to the user provides an indication as to whether or not the grill is powered on, the presentation of the notification fails to provide any specific indication as to whether or not the grill satisfies any safety-based temperature condition(s) that may be associated with the grill being used and/or operated by a human. For example, the user has no intuitive way of knowing whether the grill is too warm (e.g., too hot) to have certain of the grill's exterior surfaces be safely touched and/or contacted by the user of the grill (or by other individuals located in the vicinity of the grill). As another example, the user has no intuitive way of knowing whether the grill is cool enough (e.g., cold enough) to have certain of the grill's exterior surfaces be safely covered by a fabric cover (e.g., a vinyl, polyester, nylon, or canvas cover).

### BRIEF DESCRIPTION OF THE DRAWINGS

FIG. 1 is a block diagram of an example grill constructed in accordance with the teachings of this disclosure.

FIG. 2 is a perspective view of an example implementation of the grill of FIG. 1, with an example lid of the grill shown in an example closed position relative to an example cookbox of the grill.

FIG. 3 is a perspective view of the implementation of the grill shown in FIG. 2, with the lid of the grill shown in an example open position relative to the cookbox of the grill.

FIG. 4 is an exploded view of the implementation of the grill shown in FIGS. 2 and 3.

FIG. 5 is a perspective view of the cookbox of the implementation of the grill shown in FIGS. 2-4.

FIG. 6 a front view of an example lighting module that may be implemented as one of the lighting module(s) of FIG. 1.

FIG. 7 is a front view of the lighting module shown in FIG. 6, with the control knob of FIG. 6 removed.

FIG. 8 a front view of another example lighting module that may be implemented as one of the lighting module(s) of FIG. 1.

FIG. 9 is a front view of an example user interface that may be implemented as the user interface of FIG. 1.

FIG. 10 is a flowchart representative of example machine-readable instructions and/or example operations that may be executed by processor circuitry to implement a first safety-based temperature status monitoring process of the grill of FIG. 1.

FIG. 11 is a flowchart representative of example machine-readable instructions and/or example operations that may be executed by processor circuitry to implement a second safety-based temperature status monitoring process of the grill of FIG. 1.

FIG. 12 is a flowchart representative of example machine-readable instructions and/or example operations that may be executed by processor circuitry to implement a third safety-based temperature status monitoring process of the grill of FIG. 1.

FIG. 13 is a flowchart representative of example machine-readable instructions and/or example operations that may be executed by processor circuitry to implement a fourth safety-based temperature status monitoring process of the grill of FIG. 1.

FIG. 14 is a flowchart representative of example machine-readable instructions and/or example operations that may be executed by processor circuitry to implement a fifth safety-based temperature status monitoring process of the grill of FIG. 1.

FIG. 15 is a flowchart representative of example machine-readable instructions and/or example operations that may be executed by processor circuitry to implement a sixth safety-based temperature status monitoring process of the grill of FIG. 1.

FIG. 16 is a flowchart representative of example machine-readable instructions and/or example operations that may be executed by processor circuitry to implement a seventh safety-based temperature status monitoring process of the grill of FIG. 1.

FIG. 17 is a flowchart representative of example machine-readable instructions and/or example operations that may be executed by processor circuitry to implement an eighth safety-based temperature status monitoring process of the grill of FIG. 1.

FIG. 18 is a block diagram of an example processor platform including processor circuitry structured to execute and/or instantiate the machine-readable instructions and/or operations of FIGS. 10-17 to implement the grill of FIG. 1.

FIG. 19 is a block diagram of an example implementation of the processor circuitry of FIG. 18.

FIG. 20 is a block diagram of another example implementation of the processor circuitry of FIG. 18.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Relative to conventional grill implementations that fail to present notifications providing any specific indication as to whether or not the grill satisfies any safety-based temperature condition(s) that may be associated with the grill being used and/or operated by a human, the methods and apparatus disclosed herein advantageously present one or more notification(s) indicating that a corresponding one or more safety-based temperature condition(s) of the grill has/have been satisfied. More specifically, in some disclosed examples, a grill includes a controller and/or, more generally, a control system configured to determine whether a condition associated with a safety-based temperature status of the grill is satisfied. In response to determining that the condition is satisfied, the controller instructs a lighting module or a user interface of the grill to present a notification indicating the safety-based temperature status. In some disclosed examples, the presented notification intuitively indicates or expressly informs a user of the grill (or other individuals located in the vicinity of the grill) that the grill is too warm (e.g., too hot) to have certain of the grill's exterior surfaces be safely touched and/or contacted by a human. In other disclosed examples, the presented notification intuitively indicates or expressly informs a user of the grill (or other individuals located in the vicinity of the grill) that the grill is cool enough (e.g., cold enough) to have certain of the grill's exterior surfaces be safely covered by a fabric cover (e.g., a vinyl, polyester, nylon, or canvas cover).

The above-identified features as well as other advantageous features of example methods and apparatus for presenting safety-based temperature status notifications for grills as disclosed herein are further described below in connection with the figures of the application. As used herein in a mechanical context, the term “configured” means sized, shaped, arranged, structured, oriented, positioned, and/or located. For example, in the context of a first object configured to fit within a second object, the first object is sized, shaped, arranged, structured, oriented, positioned, and/or located to fit within the second object. As used herein in an electrical and/or computing context, the term “configured” means arranged, structured, and/or programmed. For example, in the context of a controller configured to perform a specified operation, the controller is arranged, structured, and/or programmed (e.g., based on machine-readable instructions) to perform the specified operation. As used herein, the phrase “in electrical communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, the term “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

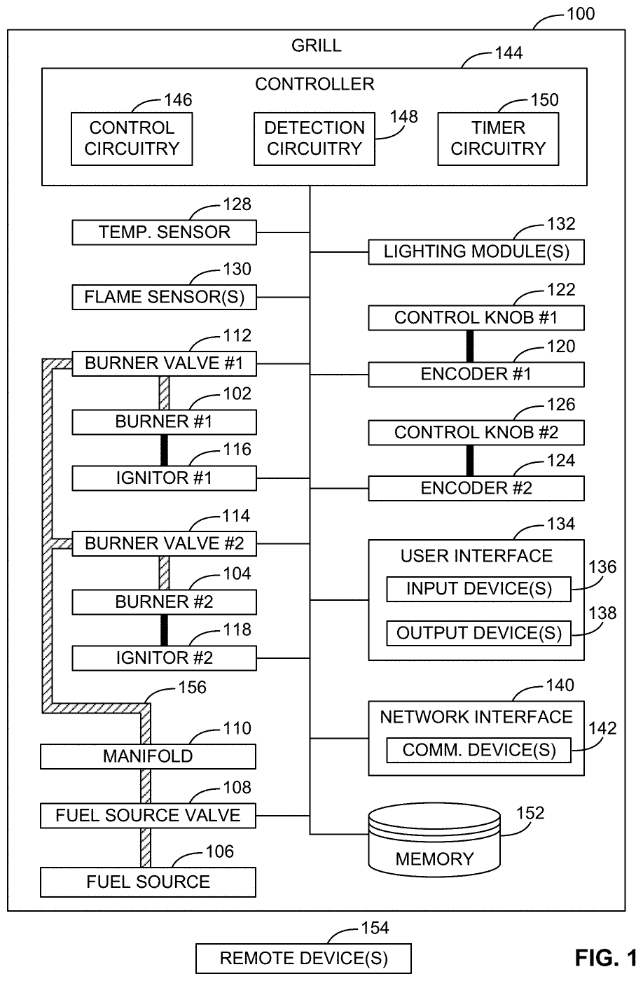

FIG. 1 is a block diagram of an example grill 100 constructed in accordance with the teachings of this disclosure. The grill 100 of FIG. 1 is a gas grill including a plurality of burners. In other examples, the grill 100 can be implemented as a different type of grill having a controllable heat source (e.g., a pellet grill, an electric grill, etc.). In the illustrated example of FIG. 1, the grill 100 includes an example first burner 102 and an example second burner 104. In other examples, the grill 100 can include one or more other burner(s) (e.g., a third burner, a fourth burner, a fifth burner, etc.) in addition to the first burner 102 and the second burner 104 shown and described in connection with FIG. 1. The first burner 102 and the second burner 104 of FIG. 1 are each constructed as a burner tube (e.g., a linear burner tube) including a gas inlet for receiving a flow of combustible gas, and further including a plurality of apertures configured to emit flames generated in response to ignition of the gas flowing into and/or through the burner tube.

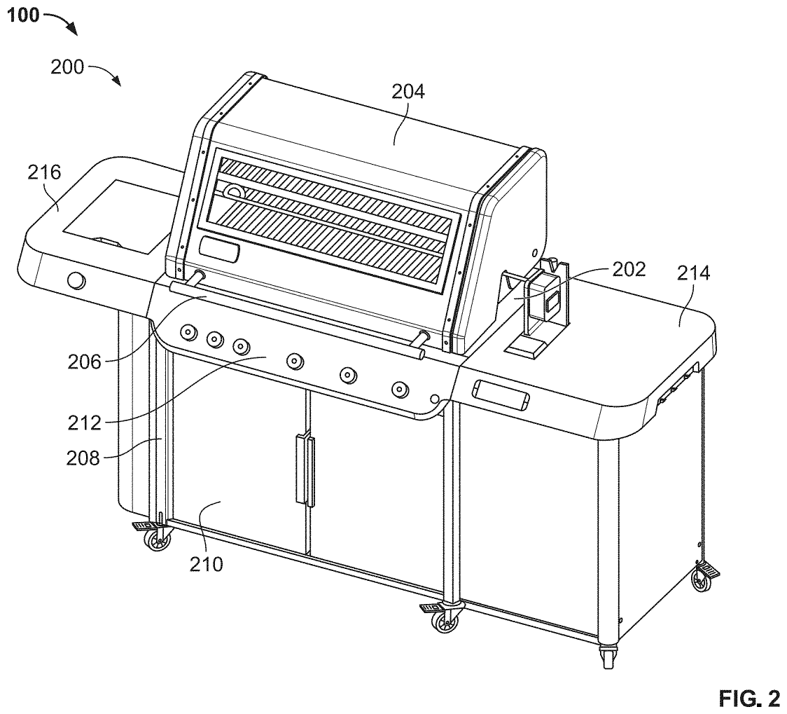

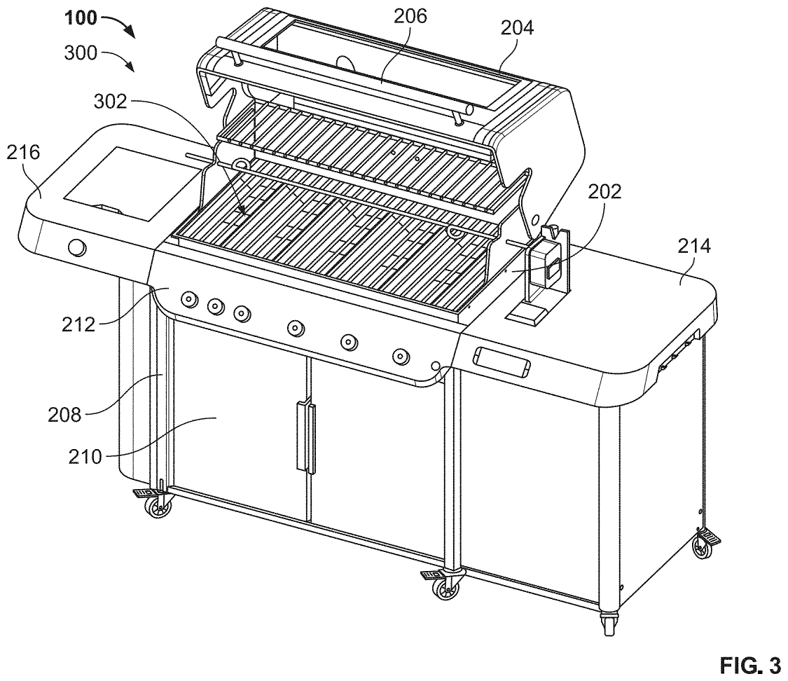

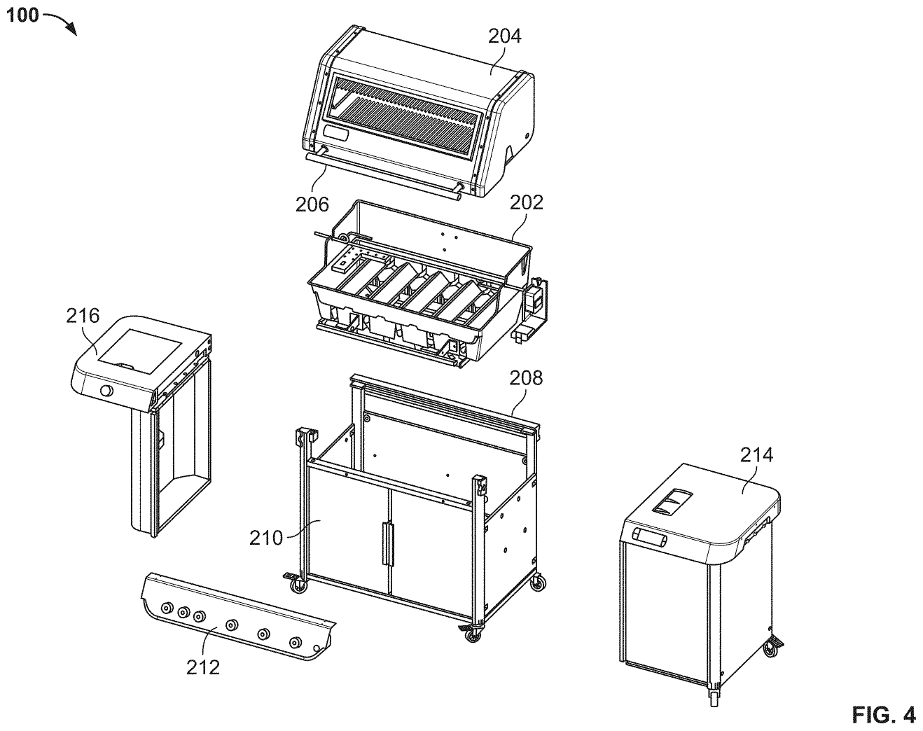

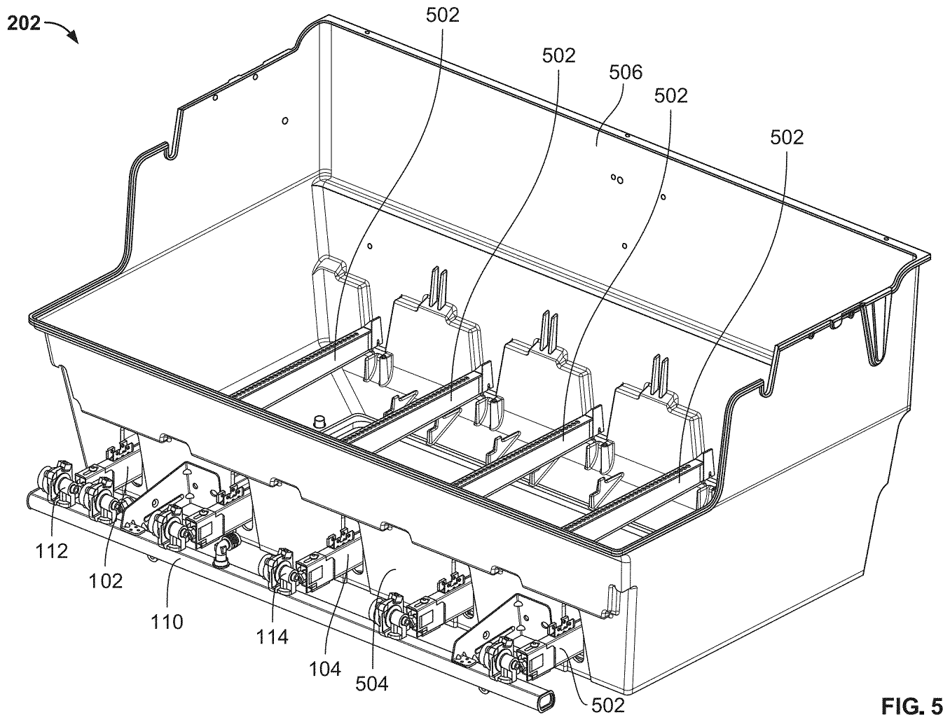

FIG. 2 is a perspective view of an example implementation of the grill 100 of FIG. 1, with an example lid 204 of the grill 100 shown in an example closed position 200 relative to an example cookbox 202 of the grill 100. FIG. 3 is a perspective view of the implementation of the grill 100 shown in FIG. 2, with the lid 204 of the grill 100 shown in an example open position 300 relative to the cookbox 202 of the grill 100. FIG. 4 is an exploded view of the implementation of the grill 100 shown in FIGS. 2 and 3. FIG. 5 is a perspective view of the cookbox 202 of the implementation of the grill 100 shown in FIGS. 2-4.

The cookbox 202 of the grill 100 supports, carries, and/or houses the burners (e.g., the first burner 102 and the second burner 104) of the grill 100, with respective ones of the burners being spaced apart from one another within the cookbox 202. As shown in FIG. 5, the cookbox 202 supports, carries, and/or houses a total of five example burners 502 (e.g., including the first burner 102 and the second burner 104 of FIG. 1), with each of the five burners 502 being spaced apart from one another within the cookbox 202. In other examples, the cookbox 202 can support, carry, and/or house a different number (e.g., two, three, four, six, etc.) of burners 502. In the illustrated example of FIGS. 2-5, each of the burners 502 is constructed as a linear burner tube positioned in a front-to-rear orientation within the cookbox 202 (e.g., extending from a front wall 504 of the cookbox 202 to a rear wall 506 of the cookbox 202). In other examples, one or more of the burner(s) 502 can have a different shape (e.g., a non-linear shape such as a P-tube), and/or can have a different orientation (e.g., a left-to-right orientation) within the cookbox 202. It should accordingly be understood that the cookbox configuration shown in FIGS. 2-5 is but one example of a cookbox 202 that can be implemented as part of the grill 100 of FIG. 1.

The lid 204 of the grill 100 is configured to cover and/or enclose the cookbox 202 of the grill 100 when the lid is in a closed position (e.g., the closed position 200 of FIG. 2). In the illustrated example of FIGS. 2-4, the lid 204 is movably (e.g., pivotally) coupled to the cookbox 202 such that the lid 204 can be moved (e.g., pivoted) relative to the cookbox 202 between a closed position (e.g., the closed position 200 of FIG. 2) and an open position (e.g., the open position 300 of FIG. 3). In other examples, the lid 204 of the grill 100 can instead be removably positioned on the cookbox 202 of the grill 100 without there being any direct mechanical coupling between the lid 204 and the cookbox 202. In some such other examples, the lid 204 can be movably (e.g., pivotally) coupled to one or more structure(s) of the grill 100 other than the cookbox 202. For example, the lid 204 can be movably (e.g., pivotally) coupled to a frame, to a cabinet, and/or to one or more side table(s) of the grill 100. Movement of the lid 204 of the grill 100 between the closed position 200 shown in FIG. 2 and the open position 300 shown in FIG. 3 can be facilitated via user interaction with an example handle 206 of the grill 100 that is coupled to the lid 204.

In the illustrated example of FIGS. 2-4, the cookbox 202 and the lid 204 of the grill 100 collectively define an example cooking chamber 302 configured to cook one or more item(s) of food. The cooking chamber 302 of the grill 100 becomes accessible to a user of the grill 100 when the lid 204 of the grill 100 is in the open position 300 shown in FIG. 3. Conversely, the cooking chamber 302 of the grill 100 is generally inaccessible to the user of the grill 100 when the lid 204 of the grill 100 is in the closed position 200 shown in FIG. 2. User access to the cooking chamber 302 of the grill 100 may periodically become necessary, for example, to add an item of food to the cooking chamber 302 (e.g., at or toward the beginning of a cook), to remove an item of food from the cooking chamber 302 (e.g., at or toward the end of a cook), and/or to flip, rotate, relocate, or otherwise move an item of food within the cooking chamber 302 (e.g., during the middle of a cook).

As further shown in FIGS. 2-4, the grill 100 includes an example frame 208 that supports the cookbox 202 of the grill 100. In the illustrated example of FIGS. 2-4, the frame 208 forms an example cabinet 210 within which one or more component(s) of the grill 100 can be housed and/or stored. In other examples, the cabinet 210 of the grill 100 can be omitted in favor of an open-space configuration of the frame 208. As further shown in FIGS. 2-4, the grill 100 includes an example control panel 212 located along the front portion of the cookbox 202, the frame 208, and/or the cabinet 210 of the grill 100, an example first side table 214 located on a first side (e.g., a right side) of the cookbox 202, the frame 208, and/or the cabinet 210 of the grill 100, and an example second side table 216 located on a second side (e.g., a left side) of the cookbox 202, the frame 208, and/or the cabinet 210 of the grill 100. Various components of the grill 100 of FIG. 1 described herein can be supported by, carried by, housed by, mounted to, and/or otherwise coupled to at least one of the cookbox 202, the lid 204, the handle 206, the frame 208, the cabinet 210, the control panel 212, the first side table 214, and/or the second side table 216 of the grill 100.

Returning to the illustrated example of FIG. 1, the grill 100 of FIG. 1 further includes an example fuel source 106, an example fuel source valve 108, an example manifold 110, an example first burner valve 112, an example second burner valve 114, an example first ignitor 116, an example second ignitor 118, an example first encoder 120, an example first control knob 122, an example second encoder 124, an example second control knob 126, an example temperature sensor 128, one or more example flame sensor(s) 130, one or more example lighting module(s) 132, an example user interface 134 (e.g., including one or more example input device(s) 136 and one or more example output device(s) 138), an example network interface 140 (e.g., including one or more example communication device(s) 142), an example controller 144 (e.g., including example control circuitry 146, example detection circuitry 148, and example timer circuitry 150), and an example memory 152. The grill 100 of FIG. 1 is configured to communicate (e.g., wirelessly communicate) with one or more example remote device(s) 154, as further described below.

The grill 100 of FIG. 1 includes a control system for controlling, managing, performing, and/or otherwise carrying out one or more operation(s) of the grill 100 including, for example, for presenting safety-based temperature status notifications associated with the grill 100. In the illustrated example of FIG. 1, the control system of the grill 100 includes the fuel source valve 108, the first burner valve 112, the second burner valve 114, the first ignitor 116, the second ignitor 118, the first encoder 120, the second encoder 124, the temperature sensor 128, the flame sensor(s) 130, the lighting module(s) 132, the user interface 134 (e.g., including the input device(s) 136 and the output device(s) 138), the network interface 140 (e.g., including the communication device(s) 142), the controller 144 (e.g., including the control circuitry 146, the detection circuitry 148, and the timer circuitry 150), and the memory 152. In other examples, one or more of the aforementioned components of the grill 100 can be omitted from the control system of the grill 100. For example, the fuel source valve 108 can be omitted from the control system of the grill 100 in instances where the fuel source valve 108 is not configured to be electrically controlled and/or electrically actuated by the controller 144, with the fuel source valve 108 instead being configured only for manual control and/or manual actuation. In still other examples, the control system of the grill 100 can further include the remote device(s) 154 that are configured to communicate (e.g., wirelessly communicate) with the grill 100.

The control system of the grill 100 of FIG. 1 is powered and/or operated by a power source. For example, the electrical components that form the control system of the grill 100 can be powered and/or operated by DC power supplied via one or more on-board or connected batteries of the grill 100. As another example, the electrical components that form the control system of the grill 100 can alternatively be powered and/or operated by AC power supplied via household electricity or wall power to which the grill 100 is connected. The grill 100 includes a power button (e.g., a power switch) that is configured to enable (e.g., power on) or disable (e.g., power off) the control system of the grill 100 in response to the power button being manually actuated by a user of the grill 100.

The grill 100 of FIG. 1 further includes an example gas train 156 that extends from the fuel source 106 to the manifold 110 of the grill 100, and from the manifold 110 to respective ones of the first burner 102 and the second burner 104 of the grill 100. The gas train 156 can be implemented via one or more conduit(s) (e.g., one or more rigid or flexible pipe(s), tube(s), etc.) that are configured to carry combustible gas from the fuel source 106 to the first burner 102 and/or the second burner 104 of the grill 100. In some examples, the fuel source 106 is implemented as a fuel tank (e.g., a propane tank) containing combustible gas. In such examples, the fuel source 106 will typically be located partially or fully within the cabinet 210 of the grill 100, partially or fully within a spatial footprint formed by the frame 208 of the grill 100, below the cookbox 202 of the grill 100 and partially or fully within a spatial footprint formed by the cookbox 202 of the grill 100, or below the cookbox 202 of the grill 100 and partially or fully within a spatial footprint formed by the first side table 214 or the second side table 216 of the grill 100. In other examples, the fuel source 106 can instead be implemented as a piped (e.g., household) natural gas line that provides an accessible flow of combustible gas.

The fuel source valve 108 of FIG. 1 is coupled to and operatively positioned within the gas train 156 between the fuel source 106 and the manifold 110 of the grill 100. The fuel source valve 108 is configured to be movable between a closed position that prevents gas contained within the fuel source 106 from flowing into the manifold 110, and an open position that enables gas contained within the fuel source 106 to flow from the fuel source 106 into the manifold 110. In the illustrated example of FIG. 1, the fuel source valve 108 is operatively coupled to (e.g., in electrical communication with) the controller 144 of the grill 100, with the fuel source valve 108 being implemented as a controllable electric valve (e.g., a solenoid valve) that is configured to transition from the closed position to the open position, and vice-versa, in response to instructions, commands, and/or signals (e.g., a supply of current) generated by the controller 144. In other examples, the fuel source valve 108 can instead be implemented as a valve having a knob or a lever operatively coupled (e.g., mechanically coupled) thereto, with the knob or the lever being configured to be electrically actuated (e.g., via a motor) in response to instructions, commands, and/or signals generated by the controller 144 of the grill 100. In still other examples, the fuel source valve 108 may have no electrically-controllable components, in which case actuation of the fuel source valve 108 from the closed position to the open position, and vice-versa, occurs in response to a user of the grill 100 manually actuating a knob or a lever that is operatively coupled (e.g., mechanically coupled) to the fuel source valve 108.

The first burner valve 112 of FIG. 1 is coupled to and operatively positioned within the gas train 156 between the manifold 110 and the first burner 102 of the grill 100. In some examples, a gas inlet of the first burner valve 112 is located within the manifold 110, and a gas outlet of the first burner valve 112 is located within the first burner 102. The first burner valve 112 is configured to be movable between a closed position that prevents gas contained within the manifold 110 from flowing into the first burner 102, and an open position that enables gas contained within the manifold 110 to flow from the manifold 110 into the first burner 102. In the illustrated example of FIG. 1, the first burner valve 112 is operatively coupled to (e.g., in electrical communication with) the controller 144 of the grill 100, with the first burner valve 112 being is implemented as a controllable electric valve (e.g., a solenoid valve) that is configured to transition from the closed position to the open position, and vice-versa, in response to instructions, commands, and/or signals (e.g., a supply of current) generated by the controller 144. In some examples, the first burner valve 112 is controllable to any position (e.g., infinite position control) between the above-described closed position (e.g., fully closed) and the above-described open position (e.g., fully open). In such examples, the first burner valve 112 of FIG. 1 may be controlled to different positions to achieve different specified temperatures (e.g., different setpoint temperatures) within the cooking chamber 302 of the grill 100, as may be required by the various ordered steps, instructions, and/or operations of one or more selectable cook program(s) to be implemented via the control system of the grill 100.

The second burner valve 114 of FIG. 1 is coupled to and operatively positioned within the gas train 156 between the manifold 110 and the second burner 104 of the grill 100. In some examples, a gas inlet of the second burner valve 114 is located within the manifold 110, and a gas outlet of the second burner valve 114 is located within the second burner 104. The second burner valve 114 is configured to be movable between a closed position that prevents gas contained within the manifold 110 from flowing into the second burner 104, and an open position that enables gas contained within the manifold 110 to flow from the manifold 110 into the second burner 104. In the illustrated example of FIG. 1, the second burner valve 114 is operatively coupled to (e.g., in electrical communication with) the controller 144 of the grill 100, with the second burner valve 114 being implemented as a controllable electric valve (e.g., a solenoid valve) that is configured to transition from the closed position to the open position, and vice-versa, in response to instructions, commands, and/or signals (e.g., a supply of current) generated by the controller 144. In some examples, the second burner valve 114 is controllable to any position (e.g., infinite position control) between the above-described closed position (e.g., fully closed) and the above-described open position (e.g., fully open). In such examples, the second burner valve 114 of FIG. 1 may be controlled to different positions to achieve different specified temperatures (e.g., different setpoint temperatures) within the cooking chamber 302 of the grill 100, as may be required by the various ordered steps, instructions, and/or operations of one or more selectable cook program(s) to be implemented via the control system of the grill 100.

In some examples, the first burner valve 112 and the second burner valve 114 of FIG. 1 respectively differ from known burner valves of conventional gas grills in that neither the first burner valve 112 nor the second burner valve 114 includes a stem that is mechanically coupled to a user-accessible control knob of the grill, whereby the control knob traditionally facilitates manual control and/or manual actuation of the operable position of the burner valve. In such examples, the first burner valve 112 and the second burner valve 114 of FIG. 1 are accordingly only controllable and/or actuatable via the “control-by-wire” functionality further described herein.

The first ignitor 116 of FIG. 1 is mechanically coupled and/or operatively positioned relative to the first burner 102 of the grill 100. More specifically, the first ignitor 116 is located adjacent the first burner 102 at a position that enables the first ignitor 116 to ignite combustible gas as the gas emanates from within the first burner 102 via apertures formed in the first burner 102. The first ignitor 116 of FIG. 1 is operatively coupled to (e.g., in electrical communication with) the controller 144 of the grill 100, with the first ignitor 116 being configured to generate sparks (e.g., via a spark electrode of the first ignitor 116) and/or otherwise induces ignition of the combustible gas in response to an instruction, a command, and/or a signal generated by the controller 144.

The second ignitor 118 of FIG. 1 is mechanically coupled and/or operatively positioned relative to the second burner 104 of the grill 100. More specifically, the second ignitor 118 is located adjacent the second burner 104 at a position that enables the second ignitor 118 to ignite combustible gas as the gas emanates from within the second burner 104 via apertures formed in the second burner 104. The second ignitor 118 of FIG. 1 is operatively coupled to (e.g., in electrical communication with) the controller 144 of the grill 100, with the second ignitor 118 being configured to generate sparks (e.g., via a spark electrode of the second ignitor 118) and/or otherwise induces ignition of the combustible gas in response to an instruction, a command, and/or a signal generated by the controller 144.

In some examples, the first ignitor 116 and/or the second ignitor 118 of FIG. 1 can respectively be structured, configured, and/or implemented as one of the various ignitors described in U.S. patent application Ser. No. 17/144,038, filed on Jan. 7, 2021. In such examples, the first ignitor 116 and/or the second ignitor 118 of FIG. 1 can respectively be mechanically coupled to a corresponding one of the first burner 102 and/or the second burner 104 of the grill 100 via a ceramic harness as described in U.S. patent application Ser. No. 17/144,038. The entirety of U.S. patent application Ser. No. 17/144,038 is hereby incorporated by reference herein.

The first encoder 120 of FIG. 1 is mechanically coupled to the first control knob 122 of FIG. 1 and operatively coupled to (e.g., in electrical communication with) the controller 144 of FIG. 1. In this regard, the first encoder 120 of FIG. 1 is implemented as a rotary encoder having a rotatable shaft to which the first control knob 122 is mechanically coupled. The rotatable shaft of the first encoder 120 can be rotated relative to a fixed portion of the first encoder 120 via user interaction with the first control knob 122 (e.g., manual rotation of the first control knob 122). The fixed portion of the first encoder 120 includes one or more sensor(s) that is/are configured to sense, measure, and/or detect the relative angular position of the rotatable shaft and/or the relative angular position of the first control knob 122. Data, information, and/or signals that is/are sensed, measured, and/or detected by the sensor(s) of the first encoder 120 can be transmitted directly to the controller 144 of FIG. 1, and/or can be transmitted to and stored in the memory 152 of FIG. 1. In some examples, the sensor(s) of the first encoder 120 is/are further configured to sense, measure, and/or detect a translational movement of the rotatable shaft relative to the fixed portion of the first encoder 120, as may occur in response to a user of the grill 100 pushing or pressing on the first control knob 122 in a direction that is generally perpendicular to the direction(s) in which the first control knob 122 is configured to be rotated by the user.

In some examples, the first encoder 120 of FIG. 1 is mounted to the control panel 212 of the grill 100 such that the first encoder 120 is located at a position on the control panel 212 that would conventionally be occupied by a stem of a burner valve that corresponds to the first burner valve 112 of FIG. 1. Such an example further facilitates locating the first control knob 122 of FIG. 1 at a position on or along the control panel 212 that would conventionally be occupied by a control knob that is mechanically coupled to the stem of the burner valve that corresponds to the first burner valve 112 of FIG. 1. While the first control knob 122 of FIG. 1 may accordingly be located at a position on or along the control panel 212 of the grill 100 that mimics the position at which a traditional control knob is located, user actuation (e.g., manual rotation) of the first control knob 122 of FIG. 1 provides a response that differs greatly from that provided by user actuation (e.g., manual rotation) of a traditional control knob.

For example, conventional multi-burner gas grills typically include a plurality of control knobs (e.g., located on or along a control panel of the grill), with each control knob being physically associated with a corresponding one of the burners of the gas grill by virtue of (1) a first mechanical connection existing between the control knob and a stem of a corresponding burner valve (e.g., such that rotation of the control knob by a user of the grill opens, closes, or otherwise adjusts the position of the burner valve), and (2) a second mechanical connection existing between the burner valve and the corresponding burner. By contrast, the grill 100 of FIG. 1 implements a “control-by-wire” architecture that eliminates the first of the aforementioned mechanical connections in favor of (1) a mechanical connection existing between the first control knob 122 of FIG. 1 and the first encoder 120 of FIG. 1, (2) a first electrical connection existing between the first encoder 120 of FIG. 1 and the controller 144 and/or the memory 152 of FIGS. 1, and (3) a second electrical connection existing between the controller 144 of FIG. 1 and the first burner valve 112 of FIG. 1.

Although the first control knob 122 of FIG. 1 is not mechanically coupled to the first burner valve 112 of FIG. 1, rotation of the first control knob 122 by a user of the grill 100 can nonetheless cause the first burner valve 112 to open, close, or otherwise adjust its position. In this regard, the controller 144 of FIG. 1 is configured to interpret different rotational positions of the first control knob 122 of FIG. 1 (e.g., as sensed, measured, and/or detected by the first encoder 120 of FIG. 1) as being indicative of correlated user requests associated with different operational states (e.g., ignite, high, medium, low, or off) of the first burner 102 of FIG. 1. For example, in response to determining that the first control knob 122 has been positioned at a relative angle of negative one hundred eighty degrees (−180°), the controller 144 may interpret the determined rotational position as a user request that the first burner 102 operate in a “medium” state. To satisfy the user request indicated by the determined rotational position of the first control knob 122, the controller 144 may instruct, command, and/or signal the first burner valve 112 of FIG. 1 to assume a partially open (e.g., 50% open) position that facilitates a “medium” flow of gas through the first burner valve 112 and into the first burner 102, thereby effecting the “medium” operational state of the first burner 102.

As another example, in response to determining that the first control knob 122 has been positioned at a relative angle of negative ninety degrees (−90°), the controller 144 may interpret the determined rotational position as a user request that the first burner 102 operate in a “high” state. To satisfy the user request indicated by the determined rotational position of the first control knob 122, the controller 144 may instruct, command, and/or signal the first burner valve 112 of FIG. 1 to assume a fully open (e.g., 100% open) position that facilitates a “high” flow of gas through the first burner valve 112 and into the first burner 102, thereby effecting the “high” operational state of the first burner 102. As yet another example, in response to determining that the first control knob 122 has been positioned at a relative angle of zero degrees (0°), the controller 144 may interpret the determined rotational position as a user request that the first burner 102 be placed in an “off” state. To satisfy the user request indicated by the determined rotational position of the first control knob 122, the controller 144 may instruct, command, and/or signal the first burner valve 112 of FIG. 1 to assume a fully closed (e.g., 0% open, or 100% closed) position that prevents any flow of gas through the first burner valve 112 and into the first burner 102, thereby effecting the “off” state of the first burner 102.

As yet another example, in response to determining that the first control knob 122 has been pushed and/or pressed inward, the controller 144 may interpret the determined translational position as a user request that the first burner 102 be ignited. To satisfy the user request indicated by the determined translational position of the first control knob 122, the controller 144 may instruct, command, and/or signal the first burner valve 112 of FIG. 1 to assume a fully open (e.g., 100% open) position that facilitates a “high” flow of gas through the first burner valve 112 and into the first burner 102. The controller 144 may further instruct, command, and/or signal the first ignitor 116 of FIG. 1 to ignite the flow of gas emanating from the first burner 102, thereby effecting the “ignited” state of the first burner 102. As yet another example, in response to determining that the first control knob 122 has been pushed and/or pressed inward, the controller 144 may interpret the determined translational position as a user request that all burners (e.g., the first burner 102 and the second burner 104) of the grill 100 be ignited. To satisfy the user request indicated by the determined translational position of the first control knob 122, the controller 144 may instruct, command, and/or signal the first burner valve 112 and the second burner valve 114 of FIG. 1 to respectively assume (e.g., either concurrently, or sequentially) a fully open (e.g., 100% open) position that facilitates a “high” flow of gas through the first burner valve 112 and into the first burner 102, as well as a “high” flow of gas through the second burner valve 114 and into the second burner 104. The controller 144 may further instruct, command, and/or signal the first ignitor 116 and the second ignitor 118 of FIG. 1 to respectively ignite (e.g., either concurrently or sequentially) the flow of gas emanating from the first burner 102 and the flow of gas emanating from the second burner 104, thereby effecting the “ignited” state of both the first burner 102 and the second burner 104.

The second encoder 124 of FIG. 1 is mechanically coupled to the second control knob 126 of FIG. 1 and operatively coupled to (e.g., in electrical communication with) the controller 144 of FIG. 1. In this regard, the second encoder 124 of FIG. 1 is implemented as a rotary encoder having a rotatable shaft to which the second control knob 126 is mechanically coupled. The rotatable shaft of the second encoder 124 can be rotated relative to a fixed portion of the second encoder 124 via user interaction with the second control knob 126 (e.g., manual rotation of the second control knob 126). The fixed portion of the second encoder 124 includes one or more sensor(s) that is/are configured to sense, measure, and/or detect the relative angular position of the rotatable shaft and/or the relative angular position of the second control knob 126. Data, information, and/or signals that is/are sensed, measured, and/or detected by the sensor(s) of the second encoder 124 can be transmitted directly to the controller 144 of FIG. 1, and/or can be transmitted to and stored in the memory 152 of FIG. 1. In some examples, the sensor(s) of the second encoder 124 is/are further configured to sense, measure, and/or detect a translational movement of the rotatable shaft relative to the fixed portion of the second encoder 124, as may occur in response to a user of the grill 100 pushing or pressing on the second control knob 126 in a direction that is generally perpendicular to the direction(s) in which the second control knob 126 is configured to be rotated by the user.

In some examples, the second encoder 124 of FIG. 1 is mounted to the control panel 212 of the grill 100 such that the second encoder 124 is located at a position on the control panel 212 that would conventionally be occupied by a stem of a burner valve that corresponds to the second burner valve 114 of FIG. 1. Such an example further facilitates locating the second control knob 126 of FIG. 1 at a position on or along the control panel 212 that would conventionally be occupied by a control knob that is mechanically coupled to the stem of the burner valve that corresponds to the second burner valve 114 of FIG. 1. While the second control knob 126 of FIG. 1 may accordingly be located at a position on or along the control panel 212 of the grill 100 that mimics the position at which a traditional control knob is located, user actuation (e.g., manual rotation) of the second control knob 126 of FIG. 1 provides a response that differs greatly from that provided by user actuation (e.g., manual rotation) of a traditional control knob.

For example, conventional multi-burner gas grills typically include a plurality of control knobs (e.g., located on or along a control panel of the grill), with each control knob being physically associated with a corresponding one of the burners of the gas grill by virtue of (1) a first mechanical connection existing between the control knob and a stem of a corresponding burner valve (e.g., such that rotation of the control knob by a user of the grill opens, closes, or otherwise adjusts the position of the burner valve), and (2) a second mechanical connection existing between the burner valve and the corresponding burner. By contrast, the grill 100 of FIG. 1 implements a “control-by-wire” architecture that eliminates the first of the aforementioned mechanical connections in favor of (1) a mechanical connection existing between the second control knob 126 of FIG. 1 and the second encoder 124 of FIG. 1, (2) a first electrical connection existing between the second encoder 124 of FIG. 1 and the controller 144 and/or the memory 152 of FIGS. 1, and (3) a second electrical connection existing between the controller 144 of FIG. 1 and the second burner valve 114 of FIG. 1.

Although the second control knob 126 of FIG. 1 is not mechanically coupled to the second burner valve 114 of FIG. 1, rotation of the second control knob 126 by a user of the grill 100 can nonetheless cause the second burner valve 114 to open, close, or otherwise adjust its position. In this regard, the controller 144 of FIG. 1 is configured to interpret different rotational positions of the second control knob 126 of FIG. 1 (e.g., as sensed, measured, and/or detected by the second encoder 124 of FIG. 1) as being indicative of correlated user requests associated with different operational states (e.g., ignite, high, medium, low, or off) of the second burner 104 of FIG. 1. For example, in response to determining that the second control knob 126 has been positioned at a relative angle of negative one hundred eighty degrees (−180°), the controller 144 may interpret the determined rotational position as a user request that the second burner 104 operate in a “medium” state. To satisfy the user request indicated by the determined rotational position of the second control knob 126, the controller 144 may instruct, command, and/or signal the second burner valve 114 of FIG. 1 to assume a partially open (e.g., 50% open) position that facilitates a “medium” flow of gas through the second burner valve 114 and into the second burner 104, thereby effecting the “medium” operational state of the second burner 104.

As another example, in response to determining that the second control knob 126 has been positioned at a relative angle of negative ninety degrees (−90°), the controller 144 may interpret the determined rotational position as a user request that the second burner 104 operate in a “high” state. To satisfy the user request indicated by the determined rotational position of the second control knob 126, the controller 144 may instruct, command, and/or signal the second burner valve 114 of FIG. 1 to assume a fully open (e.g., 100% open) position that facilitates a “high” flow of gas through the second burner valve 114 and into the second burner 104, thereby effecting the “high” operational state of the second burner 104. As yet another example, in response to determining that the second control knob 126 has been positioned at a relative angle of zero degrees (0°), the controller 144 may interpret the determined rotational position as a user request that the second burner 104 be placed in an “off” state. To satisfy the user request indicated by the determined rotational position of the second control knob 126, the controller 144 may instruct, command, and/or signal the second burner valve 114 of FIG. 1 to assume a fully closed (e.g., 0% open, or 100% closed) position that prevents any flow of gas through the second burner valve 114 and into the second burner 104, thereby effecting the “off” state of the second burner 104.

As yet another example, in response to determining that the second control knob 126 has been pushed and/or pressed inward, the controller 144 may interpret the determined translational position as a user request that the second burner 104 be ignited. To satisfy the user request indicated by the determined translational position of the second control knob 126, the controller 144 may instruct, command, and/or signal the second burner valve 114 of FIG. 1 to assume a fully open (e.g., 100% open) position that facilitates a “high” flow of gas through the second burner valve 114 and into the second burner 104. The controller 144 may further instruct, command, and/or signal the second ignitor 118 of FIG. 1 to ignite the flow of gas emanating from the second burner 104, thereby effecting the “ignited” state of the second burner. As yet another example, in response to determining that the second control knob 126 has been pushed and/or pressed inward, the controller 144 may interpret the determined translational position as a user request that all burners (e.g., the first burner 102 and the second burner 104) of the grill 100 be ignited. To satisfy the user request indicated by the determined translational position of the second control knob 126, the controller 144 may instruct, command, and/or signal the first burner valve 112 and the second burner valve 114 of FIG. 1 to respectively assume (e.g., either concurrently, or sequentially) a fully open (e.g., 100% open) position that facilitates a “high” flow of gas through the first burner valve 112 and into the first burner 102, as well as a “high” flow of gas through the second burner valve 114 and into the second burner 104. The controller 144 may further instruct, command, and/or signal the first ignitor 116 and the second ignitor 118 of FIG. 1 to respectively ignite (e.g., either concurrently or sequentially) the flow of gas emanating from the first burner 102 and the flow of gas emanating from the second burner 104, thereby effecting the “ignited” state of both the first burner 102 and the second burner 104.

The temperature sensor 128 of FIG. 1 senses, measures, and/or detects the temperature within the cooking chamber 302 of the grill 100. In some examples, the temperature sensor 128 can be implemented by and/or as a thermocouple coupled to either the cookbox 202 or the lid 204 of the grill 100, and positioned in and/or extending into the cooking chamber 302 of the grill 100. Data, information, and/or signals sensed, measured, and/or detected by the temperature sensor 128 of FIG. 1 can be of any quantity, type, form, and/or format. Data, information, and/or signals sensed, measured, and/or detected by the temperature sensor 128 of FIG. 1 can be transmitted directly to the controller 144 of FIG. 1, and/or can be transmitted to and stored in the memory 152 of FIG. 1.

The flame sensor(s) 130 of the grill 100 of FIG. 1 can be implemented by any number(s), any type(s), and/or any configuration(s) of flame sensor(s). The flame sensor(s) 130 is/are configured to sense, measure, and/or detect the presence and/or the absence of a flame emanating from the first burner 102 and/or the second burner 104 of the grill 100. In some examples, one or more of the flame sensor(s) 130 of the grill 100 can be structured, configured, and/or implemented as one of the various flame sensors described in U.S. patent application Ser. No. 17/144,038, filed on Jan. 7, 2021. The entirety of U.S. patent application Ser. No. 17/144,038 is hereby incorporated by reference herein. Data, information, and/or signals sensed, measured, and/or detected by the flame sensor(s) 130 of FIG. 1 can be of any quantity, type, form, and/or format. In some examples, data, information, and/or signals sensed, measured, and/or detected by the flame sensor(s) 130 of FIG. 1 can be transmitted directly to the controller 144 of FIG. 1, and/or can be transmitted to and stored in the memory 152 of FIG. 1.

The lighting module(s) 132 of the grill 100 of FIG. 1 can be implemented by any number(s), any type(s), and/or any configuration(s) of lighting module(s). The lighting module(s) 132 of FIG. 1 is/are configured to project light (e.g., emitted from one or more incandescent, halogen, or light-emitting diode (LED) light source(s) of the lighting module(s) 132) toward or away from one or more structure(s) of the grill 100 including, for example, the cookbox 202, the lid 204, the handle 206, the frame 208, the cabinet 210, the control panel 212, the first side table 214, and/or the second side table 216 of the grill 100. In some examples, one or more of the lighting module(s) 132 is/are mechanically coupled to (e.g., fixedly connected to) the grill 100. For example, one or more of the lighting module(s) 132 can be mounted to the cookbox 202, the lid 204, the handle 206, the frame 208, the cabinet 210, the control panel 212, the first side table 214, and/or the second side table 216 of the grill 100. In such examples, the lighting module(s) 132 is/are preferably mounted to a portion of the grill 100 that enables the light source(s) of the lighting module(s) 132 to be easily viewed by a user of the grill 100, such as a front portion of the cookbox 202, a front portion of the lid 204, a front portion of the handle 206, a front portion of the frame 208, a front portion of the cabinet 210, a front portion of the control panel 212, a front portion of the first side table 214, and/or a front portion of the second side table 216 of the grill 100. In some examples, one or more of the lighting module(s) 132 can be implemented by and/or as one or more of the output device(s) 138 of the user interface 134 of the grill 100, as further described below.

One or more of the lighting module(s) 132 of the grill 100 of FIG. 1 can be implemented as a controllable electric lighting module having one or more light source(s) that is/are configured to transition from an off state (e.g., a non-light-projecting state of the light source(s) of the lighting module) to an on state (e.g., a light-projecting state of the light source(s) of the lighting module), and vice-versa, in response to instructions, commands, and/or signals (e.g., a supply of current) generated by the controller 144 of the grill 100. In some examples, one or more of the light source(s) of the lighting module(s) 132 may be commanded (e.g., by the controller 144) to illuminate in a manner that causes the light source(s) to appear as being constantly lit (e.g., in a constant light-projecting state) over a duration of time. In other examples, one or more of the light source(s) of the lighting module(s) 132 may be commanded (e.g., by the controller 144) to illuminate in a manner that causes the light source(s) to appear as being periodically lit and/or blinking (e.g., switching up and back between a light-projecting state and a non-light-projecting state) over a duration of time. In still other examples, one or more of the light source(s) of the lighting module(s) 132 may be commanded (e.g., by the controller 144) to cease illuminating such that the light source(s) appear as being constantly unlit (e.g., in a constant non-light-projecting state) over a duration of time.

In instances where one or more of the light source(s) of the lighting module(s) 132 is/are implemented as an LED, one or more of such LED(s) can be implemented as multi-color LED that can be commanded (e.g., by the controller 144) to illuminate in different colors (e.g., white, red, blue, etc.) of the color spectrum. In some such examples, one or more of the multi-color LED(s) may be commanded to illuminate in a first color (e.g., white) to indicate that the grill 100 is powered on, a second color (e.g., red or orange) to indicate that the grill 100 is warm (e.g., hot), and a third color (e.g., blue) to indicate that the grill 100 is cool (e.g., cold) following a period of time during which the grill 100 was warm. The aforementioned color scheme is advantageous in that it intuitively informs a user of the grill 100 of the specific safety-based temperature status of the grill 100. In this regard, users of various objects conventionally associate the color red (or orange) with a warm or hot status of an object, and similarly associate the color blue with a cool or cold status of an object. In other such examples, one or more of the multi-color LED(s) may be commanded to illuminate in a first color (e.g., white) to indicate that the grill 100 is powered on, a second color (e.g., red or orange) to indicate that the grill 100 is warm (e.g., hot), and to cease illuminating (e.g., no light and accordingly no color) to indicate that the grill 100 is cool (e.g., cold) following a period of time during which the grill 100 was warm.

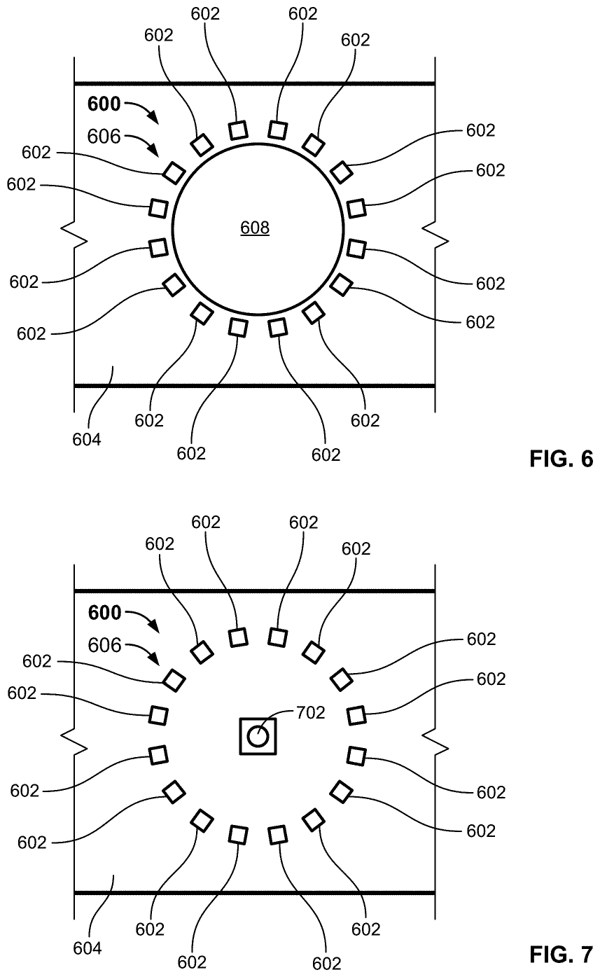

FIG. 6 a front view of an example lighting module 600 that may be implemented as one of the lighting module(s) 132 of FIG. 1. In the illustrated example of FIG. 6, the lighting module 600 includes a plurality of example LEDs 602 mounted to, positioned on, and/or otherwise located relative to an example control panel 604. As shown in FIG. 6, the LEDs 602 are configured as an example ring 606, with the ring 606 being concentrically positioned relative to an example control knob 608 that is also mounted to, positioned on, and/or otherwise located relative to the control panel 604. FIG. 7 is a front view of the lighting module 600 shown in FIG. 6, with the control knob 608 of FIG. 6 removed. As shown in FIG. 7, the ring 606 of the LEDs 602 is also concentrically positioned relative to an example rotary encoder 702 to which the control knob 608 can be mechanically coupled. In the illustrated example of FIGS. 6 and 7, the ring 606 of the LEDs 602 circumscribes the rotary encoder 702 and also circumscribes the control knob 608. In other examples (e.g., when one or more portion(s) of the control knob 608 is/are transparent or translucent), the ring 606 of the LEDs 602 may circumscribe the rotary encoder 702, and the control knob 608 may circumscribe the ring 606 of the LEDs 602. The control panel 604 of FIGS. 6 and 7 can be implemented by or as the control panel 212 of FIG. 2 described above. The control knob 608 of FIG. 6 can be implemented by and or as the first control knob 122 or the second control knob 126 of FIG. 1 described above. The rotary encoder 702 of FIG. 7 can be implemented by or as the first encoder 120 or the second encoder 124 of FIG. 1 described above.

In the illustrated example of FIGS. 6 and 7, the LEDs 602 of the lighting module 600 can be either individually or collectively controllable to transition from an off state (e.g., a non-light-projecting state) to an on state (e.g., a light-projecting state) and vice-versa, in response to instructions, commands, and/or signals (e.g., a supply of current) generated by the controller 144 of the grill 100. In this regard, the LEDs 602 can be individually or collectively commanded (e.g., by the controller 144) to illuminate in a manner that causes one or more of the LEDs 602 to appear as being constantly lit (e.g., in a constant light-projecting state) over a duration of time. The LEDs 602 can alternatively be individually or collectively commanded (e.g., by the controller 144) to illuminate in a manner that causes one or more of the LEDs 602 to appear as being periodically lit and/or blinking (e.g., switching up and back between a light-projecting state and a non-light-projecting state) over a duration of time. The LEDs 602 can alternatively be individually or collectively commanded (e.g., by the controller 144) to cease illuminating such that one or more of the LEDs 602 appear(s) as being constantly unlit (e.g., in a constant non-light-projecting state) over a duration of time.

In some examples, the LEDs 602 of the lighting module 600 of FIGS. 6 and 7 are implemented as multi-color LEDs that can be individually or collectively commanded (e.g., by the controller 144) to illuminate in different colors (e.g., white, red, blue, etc.) of the color spectrum. In some such examples, one or more of the multi-color LEDs 602 can be individually or collectively commanded to illuminate in a first color (e.g., white) to indicate that the grill 100 is powered on, a second color (e.g., red or orange) to indicate that the grill 100 is warm (e.g., hot), and a third color (e.g., blue) to indicate that the grill 100 is cool (e.g., cold) following a period of time during which the grill 100 was warm. The aforementioned color scheme is advantageous in that it intuitively informs a user of the grill 100 of the specific safety-based temperature status of the grill 100. In this regard, users of various objects conventionally associate the color red (or orange) with a warm or hot status of an object, and similarly associate the color blue with a cool or cold status of an object. In other such examples, one or more of the multi-color LEDs 602 can be individually or collectively commanded to illuminate in a first color (e.g., white) to indicate that the grill 100 is powered on, a second color (e.g., red or orange) to indicate that the grill 100 is warm (e.g., hot), and to cease illuminating (e.g., no light and accordingly no color) to indicate that the grill 100 is cool (e.g., cold) following a period of time during which the grill 100 was warm.

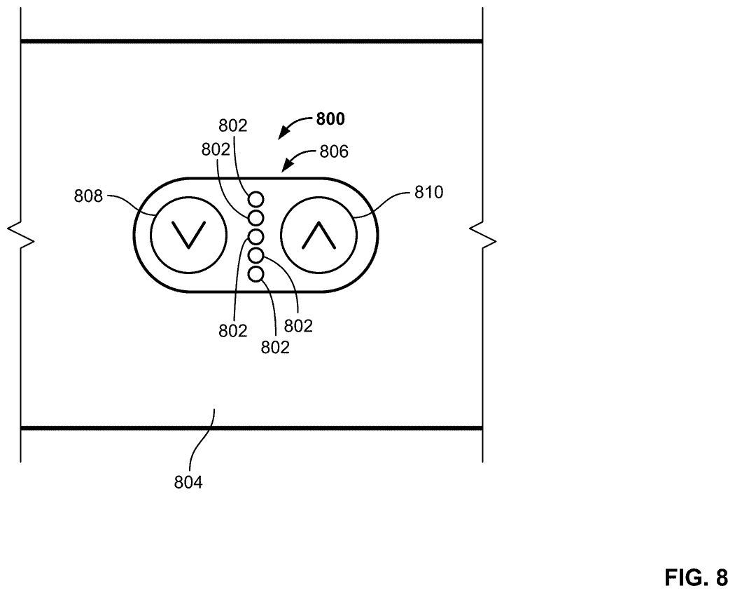

FIG. 8 a front view of another example lighting module 800 that may be implemented as one of the lighting module(s) 132 of FIG. 1. In the illustrated example of FIG. 8, the lighting module 800 includes a plurality of example LEDs 802 mounted to, positioned on, and/or otherwise located relative to an example control panel 804. As shown in FIG. 8, the LEDs 802 are configured as an example linear series 806 (e.g., a vertically-oriented column, a horizontally-oriented row, etc.), with the linear series 806 being positioned between a first example control button 808 and a second example control button 810 that are also mounted to, positioned on, and/or otherwise located relative to the control panel 804.

In the illustrated example of FIG. 6, the LEDs 802 of the lighting module 800 can be either individually or collectively controllable to transition from an off state (e.g., a non-light-projecting state) to an on state (e.g., a light-projecting state) and vice-versa, in response to instructions, commands, and/or signals (e.g., a supply of current) generated by the controller 144 of the grill 100. In this regard, the LEDs 802 can be individually or collectively commanded (e.g., by the controller 144) to illuminate in a manner that causes one or more of the LEDs 802 to appear as being constantly lit (e.g., in a constant light-projecting state) over a duration of time. The LEDs 802 can alternatively be individually or collectively commanded (e.g., by the controller 144) to illuminate in a manner that causes one or more of the LEDs 802 to appear as being periodically lit and/or blinking (e.g., switching up and back between a light-projecting state and a non-light-projecting state) over a duration of time. The LEDs 802 can alternatively be individually or collectively commanded (e.g., by the controller 144) to cease illuminating such that one or more of the LEDs 802 appear(s) as being constantly unlit (e.g., in a constant non-light-projecting state) over a duration of time.

In some examples, the LEDs 802 of the lighting module 800 of FIG. 8 are implemented as multi-color LEDs that can be individually or collectively commanded (e.g., by the controller 144) to illuminate in different colors (e.g., white, red, blue, etc.) of the color spectrum. In some such examples, one or more of the multi-color LEDs 802 can be individually or collectively commanded to illuminate in a first color (e.g., white) to indicate that the grill 100 is powered on, a second color (e.g., red or orange) to indicate that the grill 100 is warm (e.g., hot), and a third color (e.g., blue) to indicate that the grill 100 is cool (e.g., cold) following a period of time during which the grill 100 was warm. The aforementioned color scheme is advantageous in that it intuitively informs a user of the grill 100 of the specific safety-based temperature status of the grill 100. In this regard, users of various objects conventionally associate the color red (or orange) with a warm or hot status of an object, and similarly associate the color blue with a cool or cold status of an object. In other such examples, one or more of the multi-color LEDs 802 can be individually or collectively commanded to illuminate in a first color (e.g., white) to indicate that the grill 100 is powered on, a second color (e.g., red or orange) to indicate that the grill 100 is warm (e.g., hot), and to cease illuminating (e.g., no light and accordingly no color) to indicate that the grill 100 is cool (e.g., cold) following a period of time during which the grill 100 was warm.

The user interface 134 of FIG. 1 includes one or more input device(s) 136 (e.g., buttons, dials, knobs, switches, touchscreens, etc.) and/or one or more output device(s) 138 (e.g., liquid crystal displays, light emitting diodes, speakers, etc.) that enable a user of the grill 100 to interact with the above-described control system of the grill 100. In some examples, the output device(s) 138 of the user interface 134 can include one or more of the lighting module(s) 132 described above. The output device(s) 138 of the user interface 134 can be configured to present one or more notification(s) (e.g., one or more safety-based temperature status notification(s)) textually (e.g., as a written notification, message, or alert), graphically (e.g., as an illustrated or viewable notification, message, or alert), and/or audibly (e.g., as an audible notification, message, or alert). For example, the output device(s) 138 of the user interface 134 can be configured to textually (e.g., as a written notification, message, or alert), graphically (e.g., as an illustrated or viewable notification, message, or alert), and/or audibly (e.g., as an audible notification, message, or alert) inform the user of the grill 100 that the grill 100 is warm (e.g., hot). As another example, the output device(s) 138 of the user interface 134 can be configured to textually (e.g., as a written notification, message, or alert), graphically (e.g., as an illustrated or viewable notification, message, or alert), and/or audibly (e.g., as an audible notification, message, or alert) inform the user of the grill 100 that the grill 100 is cool (e.g., cold). In some examples, the presentation of such safety-based temperature status notification(s) via the output device(s) 138 of the user interface 134 may occur in response to one or more condition(s) indicative of the safety-based temperature status of the grill 100 being satisfied, as further described below.

In the illustrated example of FIG. 1, the user interface 134 is operatively coupled to (e.g., in electrical communication with) the controller 144 and/or the memory 152 of the grill 100. In some examples, the user interface 134 is mechanically coupled to (e.g., fixedly connected to) the grill 100. For example, the user interface 134 can be mounted to the cookbox 202, the lid 204, the handle 206, the frame 208, the cabinet 210, the control panel 212, the first side table 214, and/or the second side table 216 of the grill 100. The user interface 134 is preferably mounted to a portion of the grill 100 that is readily accessible to a user of the grill 100, such as a front portion of the cookbox 202, a front portion of the lid 204, a front portion of the handle 206, a front portion of the frame 208, a front portion of the cabinet 210, a front portion of the control panel 212, a front portion of the first side table 214, and/or a front portion of the second side table 216 of the grill 100.

In some examples, respective ones of the input device(s) 136 and/or the output device(s) 138 of the user interface 134 can be mounted to different portions of the grill 100. For example, a first one of the input device(s) 136 can be mounted to a side portion of either the cookbox 202, the lid 204, the handle 206, the frame 208, the cabinet 210, the control panel 212, the first side table 214, or the second side table 216 of the grill 100, and a second one of the input device(s) 136 can be mounted to a front portion of either the cookbox 202, the lid 204, the handle 206, the frame 208, the cabinet 210, the control panel 212, the first side table 214, or the second side table 216 of the grill 100. The architecture and/or operations of the user interface 134 can be distributed among any number of user interfaces respectively having any number of input device(s) 136 and/or output device(s) 138 located at and/or mounted to any portion of the grill 100.

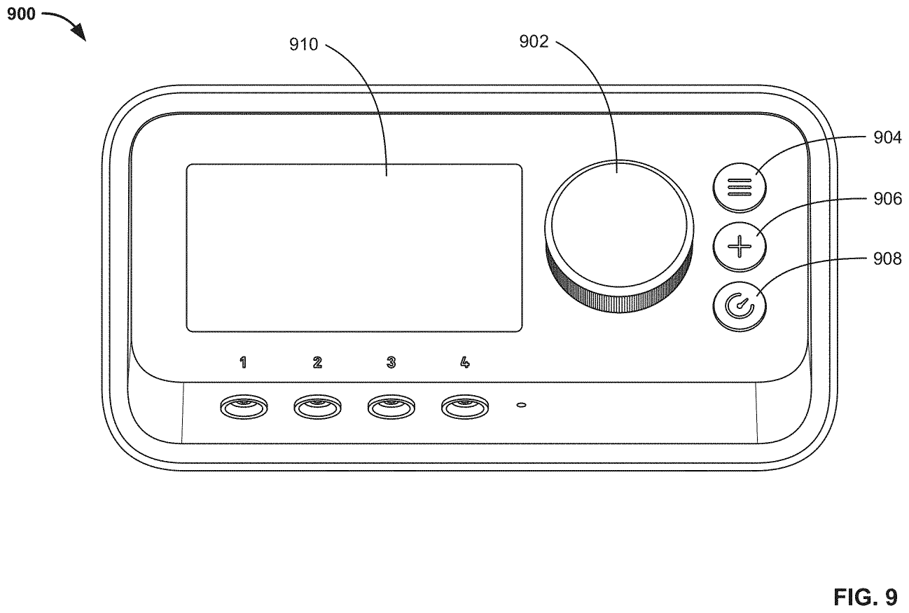

FIG. 9 a front view of an example user interface 900 that may be implemented as the user interface 134 of the grill 100 of FIG. 1. As shown in FIG. 9, the user interface 900 includes an example dial 902, an example first button 904, an example second button 906, and an example third button 908 that may be implemented as the input device(s) 136 of the user interface 134 of FIG. 1, and an example display 910 that may be implemented as the output device(s) 138 of the user interface 134 of FIG. 1. In the illustrated example of FIG. 9, the dial 902 of the user interface 900 is a selection dial that can be rotated by a user of the grill 100 to adjust temperatures of the grill 100, and/or to navigate through options presented on the display 910 of the user interface 900. In addition to being rotatable, the dial 902 can also be pushed by a user of the grill 100 to make and/or confirm a selection of one of the options presented on the display 910. The first button 904 of the user interface 900 is a menu button that can be pressed by a user of the grill 100 to access a main menu (e.g., a “home” menu) of selectable options, and to cause the main menu to be presented on the display 910 of the user interface 900. The second button 906 of the user interface 900 is a cook program button that can be pressed by a user of the grill 100 to access a library of selectable cook programs, and to cause steps, instructions, operations, notifications, and/or alerts associated with the selectable cook programs to be presented on the display 910 of the user interface 900. The third button 908 of the user interface 900 is a timer button that can be pressed by a user of the grill 100 to initiate a timer, and to cause the running time associated with the timer to be presented on the display 910 of the user interface 900. The display 910 of the user interface 900 is a liquid crystal display configured to present textual and/or graphical information to a user of the grill 100. In some examples, the display 910 can be implemented as a touch screen, in which case the display 910 can be implemented not only as one of the output device(s) 138 of the user interface 134, but also as another one of the input device(s) 136 of the user interface 134.

In some examples, one or more notification(s) presented via the display 910 of the user interface 900 may inform the user of the grill 100 of a specific safety-based temperature status of the grill 100. For example, the display 910 of the user interface 900 may textually (e.g., as a written notification, message, or alert) and/or graphically (e.g., as an illustrated or viewable notification, message, or alert) inform the user of the grill 100 that the grill 100 is warm (e.g., hot). As another example, the display 910 of the user interface 900 may textually (e.g., as a written notification, message, or alert) and/or graphically (e.g., as an illustrated or viewable notification, message, or alert) inform the user of the grill 100 that the grill 100 is cool (e.g., cold). In some examples, the presentation of such safety-based temperature status notification(s) via the display 910 of the user interface 900 may occur in response to one or more condition(s) indicative of the safety-based temperature status of the grill 100 being satisfied, as further described below.

The network interface 140 of FIG. 1 includes one or more communication device(s) 142 (e.g., transmitter(s), receiver(s), transceiver(s), modem(s), gateway(s), wireless access point(s), etc.) to facilitate exchange of data with external machines (e.g., computing devices of any kind, including the remote device(s) 154 of FIG. 1) by a wired or wireless communication network. Communications transmitted and/or received via the communication device(s) 142 and/or, more generally, via the network interface 140 can be made over and/or carried by, for example, an Ethernet connection, a digital subscriber line (DSL) connection, a telephone line connection, a coaxial cable system, a satellite system, a wireless system, a cellular telephone system, an optical connection, etc. The network interface 140 enables a user of the grill 100 to remotely interact (e.g., via one or more of the remote device(s) 154) with the above-described control system of the grill 100. In the illustrated example of FIG. 1, the network interface 140 is operatively coupled to (e.g., in electrical communication with) the controller 144 and/or the memory 152 of the grill 100.

The remote device(s) 154 of FIG. 1 can be implemented by any type(s) and/or any number(s) of mobile or stationary computing devices. In this regard, examples of such remote device(s) 154 include a smartphone, a tablet, a laptop, a desktop, a cloud server, a wearable computing device, etc. The remote device(s) 154 of FIG. 1 facilitate a remote (e.g., wired, or wireless) extension of the above-described user interface 134 of the grill 100. In this regard, each remote device 154 includes one or more input device(s) and/or one or more output device(s) that mimic and/or enable a remotely-located version of the above-described functionality of the corresponding input device(s) 136 and/or the corresponding output device(s) 138 of the user interface 134 of the grill 100. Accordingly, one or more safety-based temperature status notification(s) transmitted from the grill 100 (e.g., via the communication device(s) 142 of the network interface 140 of the grill 100) can be presented via the output device(s) of the remote device(s) 154 much in the same way that such safety-based temperature status notification(s) would be presented via the output device(s) 138 of the user interface 134 of the grill 100.

The controller 144 of FIG. 1 manages and/or controls the control system of the grill 100 and/or the components thereof. In the illustrated example of FIG. 1, the controller 144 is operatively coupled to (e.g., in electrical communication with) the fuel source valve 108, the first burner valve 112, the second burner valve 114, the first ignitor 116, the second ignitor 118, the first encoder 120, the second encoder 124, the temperature sensor 128, the flame sensor(s) 130, the lighting module(s) 132, the user interface 134 (e.g., including the input device(s) 136 and the output device(s) 138), the network interface 140 (e.g., including the communication device(s) 142), and/or the memory 152 of the grill 100 of FIG. 1. The controller 144 of FIG. 1 is also operatively coupled to (e.g., in wired or wireless electrical communication with) the remote device(s) 154 of FIG. 1 via the network interface 140 (e.g., including the communication device(s) 142) of the grill 100 of FIG. 1. In the illustrated example of FIG. 1, the controller 144 includes the control circuitry 146, the detection circuitry 148, and the timer circuitry 150 of FIG. 1, each of which is discussed in further detail herein. The control circuitry 146, the detection circuitry 148, the timer circuitry 150, and/or, more generally, the controller 144 of FIG. 1 can individually and/or collectively be implemented by any type(s) and/or any number(s) of semiconductor device(s) (e.g., processor(s), microprocessor(s), microcontroller(s), etc.) and/or circuit(s).

In the illustrated example of FIG. 1, the controller 144 is graphically represented as a single, discrete structure that manages and/or controls the operation(s) of various components of the control system of the grill 100. It is to be understood, however, that in other examples, the architecture and/or operations of the controller 144 can be distributed among any number of controllers, with each separate controller having a dedicated subset of one or more operation(s) described herein. As but one example, the controller 144 of FIG. 1 can be separated into three distinct controllers, whereby a first one of the three controllers includes the control circuitry 146 of the controller 144, a second one of the three controllers includes the detection circuitry 148 of the controller 144, and a third one of the three controllers includes the timer circuitry 150 of the controller 144. In some examples, the grill 100 can further include separate, distinct controllers for one or more of the fuel source valve 108, the first burner valve 112, the second burner valve 114, the first ignitor 116, the second ignitor 118, the first encoder 120, the second encoder 124, the temperature sensor 128, the flame sensor(s) 130, the lighting module(s) 132, the user interface 134 (e.g., including the input device(s) 136 and the output device(s) 138), the network interface 140 (e.g., including the communication device(s) 142), and/or the memory 152 of the grill 100 of FIG. 1.

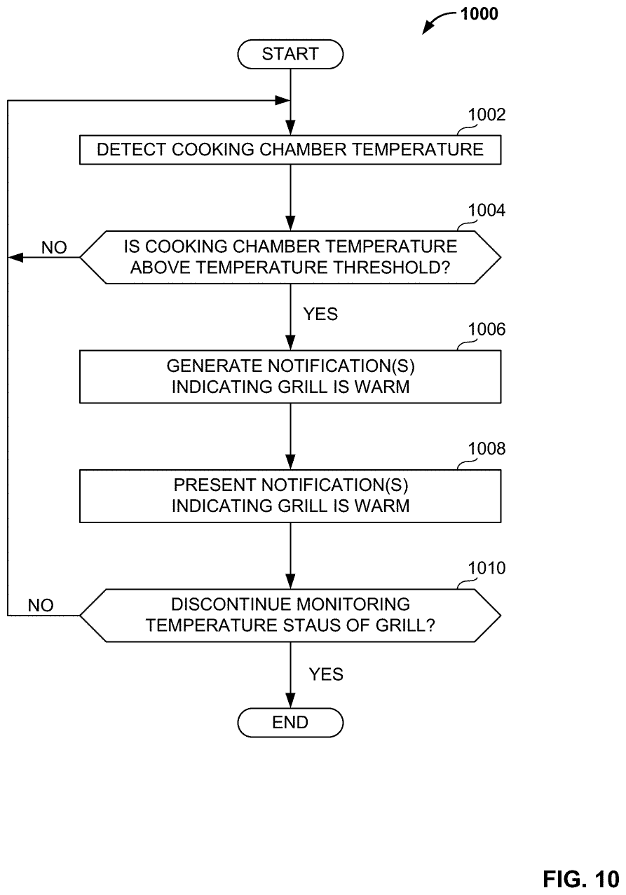

The controller 144 of FIG. 1 manages and/or controls the implementation and/or execution of one or more safety-based temperature status monitoring processes, protocols, programs, sequences, and/or methods. For example, the controller 144 may manage and/or control the implementation of one or more of the safety-based temperature status monitoring processes, protocols, programs, sequences, and/or methods described below in connection with FIGS. 9-12 which provide for the presentation of one or more safety-based temperature status notification(s) indicating that the grill 100 of FIG. 1 is warm (e.g., hot). As another example, the controller 144 may additionally or alternatively manage and/or control the implementation of one or more of the safety-based temperature status monitoring processes, protocols, programs, sequences, and/or methods described below in connection with FIGS. 10-17 which provide for the presentation of one or more safety-based temperature status notification(s) indicating that the grill 100 of FIG. 1 is cool (e.g., cold).

The control circuitry 146 of the controller 144 of FIG. 1 manages and/or controls one or more operation(s) of one or more controllable component(s) of the grill 100 that is/are operatively coupled to (e.g., in electrical communication with) the controller 144 of the grill 100. For example, the control circuitry 146 may include valve control circuitry configured to instruct, command, signal, and/or otherwise cause the fuel source valve 108, the first burner valve 112, and/or the second burner valve 114 of the grill 100 to open (e.g., fully open), to close (e.g., fully close), or to otherwise change position. The control circuitry 146 may additionally or alternatively include ignitor control circuitry configured to instruct, command, signal, and/or otherwise cause the first ignitor 116 and/or the second ignitor 118 of the grill 100 to ignite corresponding ones of the first burner 102 and/or the second burner 104 of the grill 100. The control circuitry 146 may additionally or alternatively include lighting control circuitry configured to instruct, command, signal, and/or otherwise cause one or more light source(s) of one or more of the lighting module(s) 132 of the grill 100 to transition (e.g., once, or repeatedly) from an off state (e.g., a non-light-projecting state) to an on state (e.g., a light-projecting state), or vice-versa. In some examples, the transitioning of the one or more light source(s) of one or more of the lighting module(s) 132 from the off state to the on state, or vice-versa, effects the presentation of one or more notification(s) (e.g., one or more visible message(s) or alert(s)).

The control circuitry 146 may additionally or alternatively include user interface control circuitry configured to instruct, command, signal, and/or otherwise cause one or more of the output device(s) 138 of the user interface 134 of the grill 100 to textually, graphically, or audibly present data and/or information, which may include one or more notification(s) (e.g., one or more visible, audible, and/or tactile message(s) or alert(s)). The control circuitry 146 may additionally or alternatively include network interface control circuitry configured to instruct, command, signal, and/or otherwise cause one or more of the communication device(s) 142 of the network interface 140 of the grill 100 to transmit data and/or information, which may include one or more notification(s) (e.g., one or more visible, audible, and/or tactile message(s) or alert(s)) to one or more of the remote device(s) 154 of FIG. 1.

The detection circuitry 148 of the controller 144 of FIG. 1 detects and/or determines one or more state(s), condition(s), operation(s), and/or event(s) associated with the grill 100 based on data, information, and/or signals received from one or more component(s) of the grill 100 that is/are operatively coupled to (e.g., in wired or wireless electrical communication with) the controller 144 of the grill 100. For example, the detection circuitry 148 may include valve detection circuitry configured to detect and/or determine a relative position of the fuel source valve 108, the first burner valve 112, and/or the second burner valve 114 of the grill 100 based on one or more instruction(s), command(s), and/or signal(s) generated at the control circuitry 146 of the controller 144 and/or transmitted to the fuel source valve 108, the first burner valve 112, and/or the second burner valve 114.

The detection circuitry 148 may additionally or alternatively include encoder detection circuitry configured to detect and/or determine a relative position of the first control knob 122 and/or the second control knob 126 of the grill 100 based on data, information, and/or signals received from corresponding ones of the first encoder 120 and/or the second encoder 124 of the grill 100. The detection circuitry 148 may additionally or alternatively include temperature detection circuitry configured to detect and/or determine one or more temperature state(s), condition(s), operation(s), and/or event(s) associated with the grill 100 (e.g., that a temperature of the cooking chamber 302 of the grill 100 is either above or below a predetermined temperature threshold, that a temperature of an user-contactable, external surface of the grill 100 is either above or below a predetermined temperature threshold, etc.) based on data, information, and/or signals received from the temperature sensor 128 of the grill 100. The detection circuitry 148 may additionally or alternatively include flame detection circuitry configured to detect and/or determine the presence or the absence of a flame at the first burner 102 and/or the second burner 104 of the grill 100 based on data, information, and/or signals received from one or more of the flame sensor(s) 130 of the grill 100.

The detection circuitry 148 may additionally or alternatively include user interface detection circuitry configured to detect and/or determine one or more user interface state(s), condition(s), operation(s), and/or event(s) associated with the grill 100 (e.g., that a user has interacted with one or more of the input device(s) 136 of the user interface 134, that a user has failed to interact with one or more of the input device(s) 136 of the user interface 134, etc.) based on data, information, and/or signals received from the user interface 134 of the grill 100. The detection circuitry 148 may additionally or alternatively include network interface detection circuitry configured to detect and/or determine one or more network interface state(s), condition(s), operation(s), and/or event(s) associated with the grill 100 (e.g., that one or more of the communication device(s) 142 of the network interface 140 has received data, information, and/or signals indicating that a user has interacted with one or more input device(s) of one or more of the remote device(s) 154, that one or more of the communication device(s) 142 of the network interface 140 has failed to receive data, information, and/or signals indicating that a user has interacted with one or more input device(s) of one or more of the remote device(s) 154, etc.) based on data, information, and/or signals received from the network interface 140 of the grill 100.

The timer circuitry 150 of the controller 144 of FIG. 1 controls and/or manages the implementation, invocation, initiation, termination, and/or execution of one or more timer(s) of the controller 144 and/or, more generally, of the control system of the grill 100, with each such timer having a predetermined duration (e.g., as may be stored in the memory 152 of the grill 100) associated therewith. In some examples, the predetermined duration of a timer that is controlled and/or managed via the timer circuitry 150 has an associated starting time value of zero and an associated ending time value greater than zero (e.g., a timer that increases in value over time). In other examples, the predetermined duration of a timer that is controlled and/or managed via the timer circuitry 150 has an associated starting time value greater than zero and an associated ending time value of zero (e.g., a timer that decreases in value over time). In some examples, the timer circuitry 150 detects and/or determines whether a timer has reached its associated predetermined duration. In some examples, the detection circuitry 148 of the controller 144 operates in conjunction and/or coordination with the timer circuitry 150 of the controller 144 to determine whether a condition pertaining to a safety-based temperature status of the grill 100 of FIG. 1 (e.g., as detected via the detection circuitry 148) has remained satisfied during (e.g., over and/or throughout) a predetermined duration associated with a timer being controlled and/or managed via the timer circuitry 150.

In some examples, the controller 144 and/or, more generally, the control system of the grill 100 of FIG. 1 is configured to determine whether a condition associated with a safety-based temperature status of the grill 100 is satisfied. In response to determining that the condition is satisfied, the controller 144 instructs, commands, and/or signals one or more of the lighting module(s) 132 of the grill 100, one or more of the output device(s) 138 of the user interface 134 of the grill 100, and/or one or more of the output device(s) of one or more of the remote device(s) 154 to present one or more notification(s) indicating the safety-based temperature status. In some examples, the presented notification intuitively indicates or expressly informs a user of the grill 100 (or other individuals located in the vicinity of the grill 100) that the grill 100 is too warm (e.g., such that one or more user-contactable, external surface(s) of the grill 100 exceeds a temperature of approximately one hundred forty degrees Fahrenheit (140° F.)) to have certain of the grill's exterior surfaces be safely touched and/or contacted by a human. In other examples, the presented notification intuitively indicates or expressly informs a user of the grill 100 (or other individuals located in the vicinity of the grill 100) that the grill 100 is cool enough (e.g., such that none of the user-contactable, external surfaces of the grill 100 exceed a temperature of approximately one hundred forty degrees Fahrenheit (140° F.)) to have certain of the grill's exterior surfaces be safely covered by a fabric cover (e.g., a vinyl, polyester, nylon, or canvas cover).

In some examples, the control circuitry 146 of the controller 144 of FIG. 1 instructs, commands, and/or signals one or more of the lighting module(s) 132 of the grill 100, one or more of the output device(s) 138 of the user interface 134 of the grill 100, and/or one or more of the output device(s) of one or more of the remote device(s) 154 to present one or more notification(s) indicating that the grill 100 of FIG. 1 is warm when the detection circuitry 148 of the controller 144 of FIG. 1 determines that the temperature of the cooking chamber 302 of the grill 100 (e.g., as sensed, measured, and/or detected by the temperature sensor 128 of the grill 100) is above a predetermined temperature threshold (e.g., above approximately two hundred degrees Fahrenheit (200° F.)).

In some examples, the control circuitry 146 of the controller 144 of FIG. 1 instructs, commands, and/or signals one or more of the lighting module(s) 132 of the grill 100, one or more of the output device(s) 138 of the user interface 134 of the grill 100, and/or one or more of the output device(s) of one or more of the remote device(s) 154 to present one or more notification(s) indicating that the grill 100 of FIG. 1 is warm when the detection circuitry 148 of the controller 144 of FIG. 1 determines that the temperature(s) of one or more user-contactable, external surface(s) of the grill 100 is/are above a predetermined temperature threshold (e.g., above approximately one hundred forty degrees Fahrenheit (140° F.)). In some such examples, the detection circuitry 148 of the controller 144 of FIG. 1 determines the temperature(s) of the user-contactable, external surface(s) of the grill 100 based on the temperature of the cooking chamber 302 of the grill 100 (e.g., as sensed, measured, and/or detected by the temperature sensor 128 of the grill 100). For example, the detection circuitry 148 of the controller 144 may determine the temperature(s) of the user-contactable, external surface(s) of the grill 100 by accessing a temperature correlation table (e.g., as may be stored in the memory 152 of the grill 100) that defines one or more relationship(s) between the temperature of the cooking chamber 302 of the grill 100 and the temperature(s) of various ones of the user-contactable, external surface(s) of the grill 100 (e.g., the temperature of external surface A is Y degrees Fahrenheit when the temperature of the cooking chamber 302 is X degrees Fahrenheit, the temperature of external surface B is Z degrees Fahrenheit when the temperature of the cooking chamber 302 is X degrees Fahrenheit, etc.).

In some examples, the control circuitry 146 of the controller 144 of FIG. 1 instructs, commands, and/or signals one or more of the lighting module(s) 132 of the grill 100, one or more of the output device(s) 138 of the user interface 134 of the grill 100, and/or one or more of the output device(s) of one or more of the remote device(s) 154 to present one or more notification(s) indicating that the grill 100 of FIG. 1 is warm when the detection circuitry 148 of the controller 144 of FIG. 1 determines that a flame (e.g., as sensed, measured, and/or detected by the flame sensor(s) 130 of the grill 100) is present at the first burner 102 and/or the second burner 104 of the grill 100 during (e.g., over and/or throughout) a predetermined duration associated with a timer invoked by the timer circuitry 150 of the controller 144 of FIG. 1.

In some examples, the control circuitry 146 of the controller 144 of FIG. 1 instructs, commands, and/or signals one or more of the lighting module(s) 132 of the grill 100, one or more of the output device(s) 138 of the user interface 134 of the grill 100, and/or one or more of the output device(s) of one or more of the remote device(s) 154 to present one or more notification(s) indicating that the grill 100 of FIG. 1 is warm when the detection circuitry 148 of the controller 144 of FIG. 1 determines that the first burner valve 112 and/or the second burner valve 114 of the grill 100 is/are in an open position (e.g., a fully-open or partially-open position) during (e.g., over and/or throughout) a predetermined duration associated with a timer invoked by the timer circuitry 150 of the controller 144 of FIG. 1.

In some examples, the control circuitry 146 of the controller 144 of FIG. 1 instructs, commands, and/or signals one or more of the lighting module(s) 132 of the grill 100, one or more of the output device(s) 138 of the user interface 134 of the grill 100, and/or one or more of the output device(s) of one or more of the remote device(s) 154 to present one or more notification(s) indicating that the grill 100 of FIG. 1 is cool when the detection circuitry 148 of the controller 144 of FIG. 1 determines that the temperature of the cooking chamber 302 of the grill 100 (e.g., as sensed, measured, and/or detected by the temperature sensor 128 of the grill 100) is below a predetermined temperature threshold (e.g., below approximately two hundred degrees Fahrenheit (200° F.)) subsequent to the detection circuitry 148 of the controller 144 having determined that the temperature of the cooking chamber 302 of the grill 100 was above the predetermined temperature threshold.

In some examples, the control circuitry 146 of the controller 144 of FIG. 1 instructs, commands, and/or signals one or more of the lighting module(s) 132 of the grill 100, one or more of the output device(s) 138 of the user interface 134 of the grill 100, and/or one or more of the output device(s) of one or more of the remote device(s) 154 to present one or more notification(s) indicating that the grill 100 of FIG. 1 is cool when the detection circuitry 148 of the controller 144 of FIG. 1 determines that the temperature(s) of one or more user-contactable, external surface(s) of the grill 100 is/are below a predetermined temperature threshold (e.g., below approximately one hundred forty degrees Fahrenheit (140° F.)) subsequent to the detection circuitry 148 of the controller 144 having determined that the temperature(s) of the one or more user-contactable, external surface(s) of the grill 100 was/were above the predetermined temperature threshold. In some such examples, the detection circuitry 148 of the controller 144 of FIG. 1 determines the temperature(s) of the user-contactable, external surface(s) of the grill 100 based on the temperature of the cooking chamber 302 of the grill 100 (e.g., as sensed, measured, and/or detected by the temperature sensor 128 of the grill 100). For example, the detection circuitry 148 of the controller 144 may determine the temperature(s) of the user-contactable, external surface(s) of the grill 100 by accessing a temperature correlation table (e.g., as may be stored in the memory 152 of the grill 100) that defines one or more relationship(s) between the temperature of the cooking chamber 302 of the grill 100 and the temperature(s) of various ones of the user-contactable, external surface(s) of the grill 100 (e.g., the temperature of external surface A is Y degrees Fahrenheit when the temperature of the cooking chamber 302 is X degrees Fahrenheit, the temperature of external surface B is Z degrees Fahrenheit when the temperature of the cooking chamber 302 is X degrees Fahrenheit, etc.).

In some examples, the control circuitry 146 of the controller 144 of FIG. 1 instructs, commands, and/or signals one or more of the lighting module(s) 132 of the grill 100, one or more of the output device(s) 138 of the user interface 134 of the grill 100, and/or one or more of the output device(s) of one or more of the remote device(s) 154 to present one or more notification(s) indicating that the grill 100 of FIG. 1 is cool when the detection circuitry 148 of the controller 144 of FIG. 1 determines an absence of a flame (e.g., as sensed, measured, and/or detected by the flame sensor(s) 130 of the grill 100) at the first burner 102 and the second burner 104 of the grill 100 during (e.g., over and/or throughout) a predetermined duration associated with a timer invoked by the timer circuitry 150 of the controller 144 of FIG. 1, with such a determination being subsequent to the detection circuitry 148 of the controller 144 having determined a presence of a flame at the first burner 102 and/or the second burner 104 of the grill 100.

In some examples, the control circuitry 146 of the controller 144 of FIG. 1 instructs, commands, and/or signals one or more of the lighting module(s) 132 of the grill 100, one or more of the output device(s) 138 of the user interface 134 of the grill 100, and/or one or more of the output device(s) of one or more of the remote device(s) 154 to present one or more notification(s) indicating that the grill 100 of FIG. 1 is cool when the detection circuitry 148 of the controller 144 of FIG. 1 determines that the first burner valve 112 and the second burner valve 114 of the grill 100 are in a closed position (e.g., a fully-closed position) during (e.g., over and/or throughout) a predetermined duration associated with a timer invoked by the timer circuitry 150 of the controller 144 of FIG. 1, with such a determination being subsequent to the detection circuitry 148 of the controller 144 having determined that the first burner valve 112 and/or the second burner valve 114 of the grill 100 is/are in an open position.

The memory 152 of FIG. 1 can be implemented by any type(s) and/or any number(s) of storage device(s) such as a storage drive, a flash memory, a read-only memory (ROM), a random-access memory (RAM), a cache and/or any other physical storage medium in which information is stored for any duration (e.g., for extended time periods, permanently, brief instances, for temporarily buffering, and/or for caching of the information). The information stored in the memory 152 of FIG. 1 can be stored in any file and/or data structure format, organization scheme, and/or arrangement.

The memory 152 stores data sensed, measured, detected, generated, accessed, input, output, transmitted, and/or received by, to, and/or from the fuel source valve 108, the first burner valve 112, the second burner valve 114, the first ignitor 116, the second ignitor 118, the first encoder 120, the second encoder 124, the temperature sensor 128, the flame sensor(s) 130, the lighting module(s) 132, the user interface 134 (e.g., including the input device(s) 136 and the output device(s) 138), the network interface 140 (e.g., including the communication device(s) 142), the controller 144 (e.g., including the control circuitry 146, the detection circuitry 148, and the timer circuitry 150), the remote device(s) 154, and/or, more generally, the control system of the grill 100 of FIG. 1. The memory 152 also stores instructions (e.g., machine-readable instructions) and associated data (e.g., one or more predetermined temperature threshold(s), one or more temperature correlation table(s), one or more predetermined timer duration(s), one or more predetermined presentation duration(s), etc.) corresponding to the processes, protocols, programs, sequences, and/or methods described below in connection with FIGS. 9-16. The memory 152 of FIG. 1 is accessible to one or more of the fuel source valve 108, the first burner valve 112, the second burner valve 114, the first ignitor 116, the second ignitor 118, the first encoder 120, the second encoder 124, the temperature sensor 128, the flame sensor(s) 130, the lighting module(s) 132, the user interface 134 (e.g., including the input device(s) 136 and the output device(s) 138), the network interface 140 (e.g., including the communication device(s) 142), the controller 144 (e.g., including the control circuitry 146, the detection circuitry 148, and the timer circuitry 150), the remote device(s) 154, and/or, more generally, the control system of the grill 100 of FIG. 1.

While an example manner of implementing the control system of the grill 100 is illustrated in FIG. 1, one or more of the elements, processes, and/or devices illustrated in FIG. 1 may be combined, divided, re-arranged, omitted, eliminated, and/or implemented in any other way. Further, the example fuel source valve 108, the example first burner valve 112, the example second burner valve 114, the example first ignitor 116, the example second ignitor 118, the example first encoder 120, the example second encoder 124, the example temperature sensor 128, the example flame sensor(s) 130, the example lighting module(s) 132, the example user interface 134 (e.g., including the example input device(s) 136 and the example output device(s) 138), the example network interface 140 (e.g., including the example communication device(s) 142), the example controller 144 (e.g., including the example control circuitry 146, the example detection circuitry 148, and the example timer circuitry 150), the example memory 152, and/or, more generally, the control system of the grill 100 of FIG. 1, may be implemented by hardware alone or by hardware in combination with software and/or firmware. Thus, for example, any of the example fuel source valve 108, the example first burner valve 112, the example second burner valve 114, the example first ignitor 116, the example second ignitor 118, the example first encoder 120, the example second encoder 124, the example temperature sensor 128, the example flame sensor(s) 130, the example lighting module(s) 132, the example user interface 134 (e.g., including the example input device(s) 136 and the example output device(s) 138), the example network interface 140 (e.g., including the example communication device(s) 142), the example controller 144 (e.g., including the example control circuitry 146, the example detection circuitry 148, and the example timer circuitry 150), the example memory 152, and/or, more generally, the control system of the grill 100 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example control system of the grill of FIG. 1 may include one or more elements, processes, and/or devices in addition to, or instead of, those illustrated in FIG. 1, and/or may include more than one of any or all of the illustrated elements, processes, and devices.

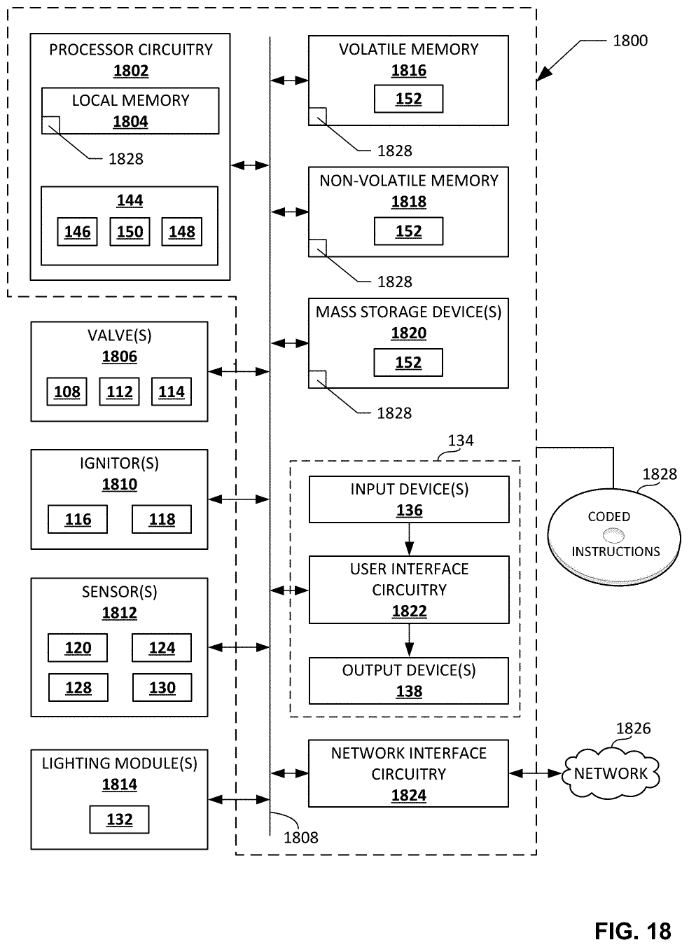

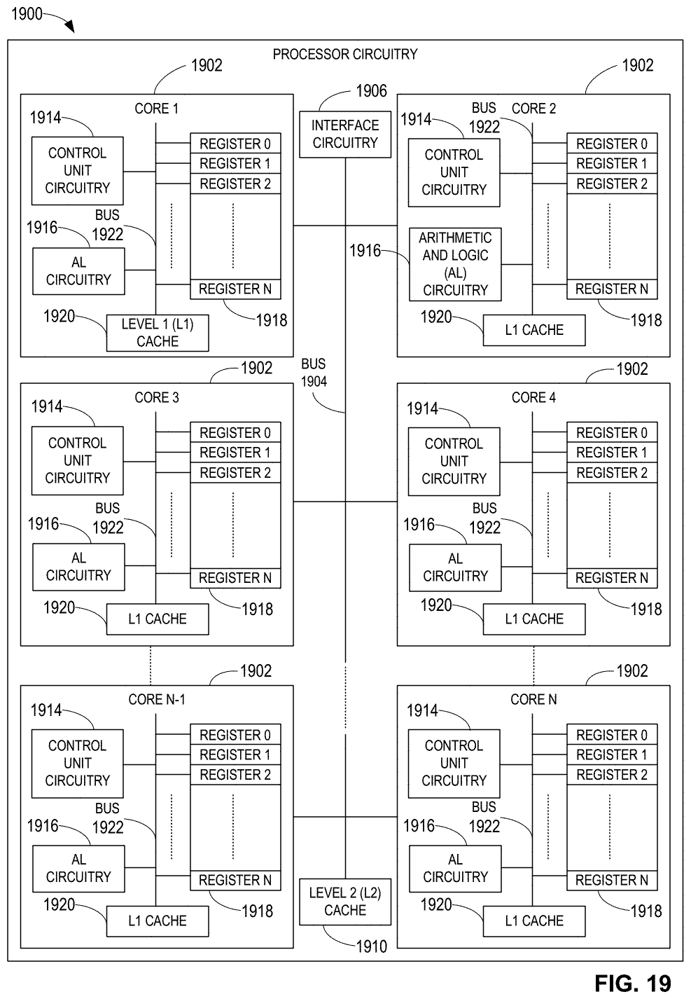

Flowcharts representing example hardware logic circuitry, machine-readable instructions, hardware implemented state machines, and/or any combination thereof for implementing the grill 100 of FIG. 1 are shown in FIGS. 10-17. The machine-readable instructions may be one or more executable program(s) or portion(s) thereof for execution by processor circuitry, such as the processor circuitry 1802 shown in the example processor platform 1800 discussed below in connection with FIG. 18 and/or the example processor circuitry discussed below in connection with FIGS. 19 and/or 20. The program(s) may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program(s) and/or the portion(s) thereof could alternatively be executed by one or more hardware devices other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although example programs are described with reference to the flowcharts illustrated in FIGS. 10-17, many other methods of implementing the example grill 100 may alternatively be used. For example, the order of execution of the blocks may be changed, and/or some of the blocks described may be changed, eliminated, or combined. Additionally, or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine-readable instructions as described herein may be stored as data or a data structure (e.g., as portions of instructions, code, representations of code, etc.) that may be utilized to create, manufacture, and/or produce machine-executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or any other machine. For example, the machine-readable instructions may be stored in multiple parts, which are individually compressed, encrypted, and/or stored on separate computing devices, wherein the parts when decrypted, decompressed, and/or combined form a set of machine-executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or any other device. In another example, the machine-readable instructions may need to be configured (e.g., settings stored, data input, network addresses recorded, etc.) before the machine-readable instructions and/or the corresponding program(s) can be executed in whole or in part. Thus, machine-readable media, as used herein, may include machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 10-17 may be implemented using executable instructions (e.g., computer and/or machine-readable instructions) stored on one or more non-transitory computer and/or machine-readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable medium” and “non-transitory computer-readable storage medium” are expressly defined to include any type of computer-readable storage device and/or storage disk and to exclude propagating signals and to exclude transmission media.

The terms “including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

FIG. 10 is a flowchart representative of example machine-readable instructions and/or example operations 1000 that may be executed by processor circuitry to implement a first safety-based temperature status monitoring process of the grill 100 of FIG. 1. The machine-readable instructions and/or operations 1000 of FIG. 10 begin at block 1002 when the detection circuitry 148 of the controller 144 of FIG. 1 detects the temperature of the cooking chamber 302 of the grill 100. For example, the detection circuitry 148 may detect (e.g., continuously, or periodically) the temperature of the cooking chamber 302 of the grill 100 based on data, information, and/or signals sensed, measured, and/or detected by the temperature sensor 128 of the grill 100. Following block 1002, control of the example machine-readable instructions and/or operations 1000 of FIG. 10 proceeds to block 1004.

At block 1004, the detection circuitry 148 of the controller 144 of FIG. 1 determines whether the temperature of the cooking chamber 302 of the grill 100 is above a temperature threshold. For example, the detection circuitry 148 may compare the temperature of the cooking chamber 302 of the grill 100 (e.g., as detected at block 1002) to a predetermined temperature threshold (e.g., as may be stored in the memory 152 of the grill 100) that corresponds to the grill 100 being warm (e.g., hot). If the detection circuitry 148 determines at block 1004 that the temperature of the cooking chamber 302 of the grill 100 is not above the temperature threshold, control of the example machine-readable instructions and/or operations 1000 of FIG. 10 returns to block 1002. If the detection circuitry 148 instead determines at block 1004 that the temperature of the cooking chamber 302 of the grill 100 is above the temperature threshold, control of the example machine-readable instructions and/or operations 1000 of FIG. 10 proceeds to block 1006.

At block 1006, the control circuitry 146 of the controller 144 of FIG. 1 generates one or more notification(s) (e.g., visible, audible, and/or tactile message(s) or alert(s)) indicating that the grill 100 is warm. In some examples, the control circuitry 146 generates one or more notification(s) that, when presented, is/are intended to expressly inform a user of the grill 100 that the grill 100 is warm. In other examples, the control circuitry 146 generates one or more notification(s) that, when presented, is/are intended to inherently and/or intuitively inform a user of the grill 100 that the grill 100 is warm. Following block 1006, control of the example machine-readable instructions and/or operations 1000 of FIG. 10 proceeds to block 1008.

At block 1008, the control circuitry 146 of the controller 144 of FIG. 1 instructs, commands, signals, and/or otherwise causes the notification(s) indicating that the grill 100 of FIG. 1 is warm to be presented locally and/or remotely. For example, the control circuitry 146 may instruct, command, signal, and/or otherwise cause one or more of the lighting module(s) 132 of the grill 100 of FIG. 1 to locally present one or more of the notification(s) indicating that the grill 100 is warm. As another example, the control circuitry 146 may additionally or alternatively instruct, command, signal, and/or otherwise cause the user interface 134 of the grill 100 of FIG. 1 to locally present (e.g., via one or more of the output device(s) 138 of the user interface 134) one or more of the notification(s) indicating that the grill 100 is warm. As yet another example, the control circuitry 146 may additionally or alternatively instruct, command, signal, and/or otherwise cause the network interface 140 of the grill 100 of FIG. 1 to transmit (e.g., via one or more of the communication device(s) 142 of the network interface 140) one or more of the notification(s) indicating that the grill 100 is warm to one or more of the remote device(s) 154 of FIG. 1 for remote presentation via one or more of the output device(s) of the remote device(s) 154. In some examples, one or more of the notification(s) indicating that the grill 100 is warm may be presented for a predetermined duration (e.g., a predetermined presentation duration, as may be stored in the memory 152 of the grill 100). In other examples, one or more of the notification(s) indicating that the grill 100 is warm may be presented until a countering event (e.g., determining that the grill 100 is no longer warm, receiving a request, command, and/or instruction to terminate the presentation of the notification(s), etc.) occurs. Following block 1008, control of the example machine-readable instructions and/or operations 1000 of FIG. 10 proceeds to block 1010.

At block 1010, the controller 144 of FIG. 1 determines whether to discontinue monitoring the temperature status of the grill 100 of FIG. 1. For example, the controller 144 may determine that a request, command, and/or instruction to discontinue monitoring the temperature status of the grill 100 has been received based on a user input, a user selection, and/or a user interaction (e.g., a press, a push, a pull, a rotation, a click, a flip, a swipe, a touch, etc.) of, to, and/or with one or more of the input device(s) 136 (e.g., a button, a dial, a knob, a switch, a touchscreen, etc.) of the user interface 134 of FIG. 1. As another example, the controller 144 may determine that a request, command, and/or instruction to discontinue monitoring the temperature status of the grill 100 has been received based on a user input, a user selection, and/or a user interaction (e.g., a press, a push, a pull, a rotation, a click, a flip, a swipe, a touch, etc.) of, to, and/or with one or more input device(s) (e.g., a button, a dial, a knob, a switch, a touchscreen, etc.) of one of the remote device(s) 154 of FIG. 1, as received and/or detected via the network interface 140 of FIG. 1. If the controller 144 determines at block 1010 that the monitoring of the temperature status of the grill 100 is to be continued, control of the machine-readable instructions and/or operations 1000 of FIG. 10 returns to block 1002. If the controller 144 instead determines at block 1010 that the monitoring of the temperature status of the grill 100 is to be discontinued, the machine-readable instructions and/or operations 1000 of FIG. 10 end.

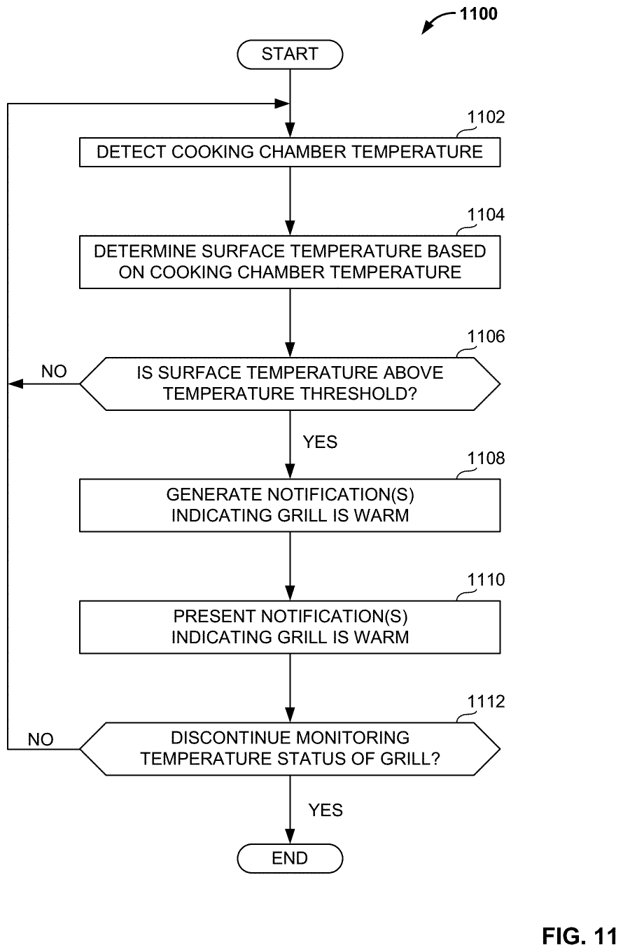

FIG. 11 is a flowchart representative of example machine-readable instructions and/or example operations 1100 that may be executed by processor circuitry to implement a second safety-based temperature status monitoring process of the grill 100 of FIG. 1. The machine-readable instructions and/or operations 1100 of FIG. 11 begin at block 1102 when the detection circuitry 148 of the controller 144 of FIG. 1 detects the temperature of the cooking chamber 302 of the grill 100. For example, the detection circuitry 148 may detect (e.g., continuously, or periodically) the temperature of the cooking chamber 302 of the grill 100 based on data, information, and/or signals sensed, measured, and/or detected by the temperature sensor 128 of the grill 100. Following block 1102, control of the example machine-readable instructions and/or operations 1100 of FIG. 11 proceeds to block 1104.

At block 1104, the detection circuitry 148 of the controller of FIG. 1 determines a temperature of a surface (e.g., a user-contactable, external surface) of the grill 100 based on the temperature of the cooking chamber 302 of the grill 100. For example, the detection circuitry 148 may determine the temperature of the surface of the grill 100 by accessing a temperature correlation table (e.g., as may be stored in the memory 152 of the grill 100) that defines one or more relationship(s) between the temperature of the cooking chamber 302 of the grill 100 and the temperature of the surface of the grill 100 (e.g., the temperature of the surface is Y degrees Fahrenheit when the temperature of the cooking chamber 302 is X degrees Fahrenheit). Following block 1104, control of the example machine-readable instructions and/or operations 1100 of FIG. 11 proceeds to block 1106.

At block 1106, the detection circuitry 148 of the controller 144 of FIG. 1 determines whether the temperature of the surface of the grill 100 is above a temperature threshold. For example, the detection circuitry 148 may compare the temperature of the surface of the grill 100 (e.g., as detected at block 1104) to a predetermined temperature threshold (e.g., as may be stored in the memory 152 of the grill 100) that corresponds to the grill 100 being warm (e.g., hot). If the detection circuitry 148 determines at block 1106 that the temperature of the surface of the grill 100 is not above the temperature threshold, control of the example machine-readable instructions and/or operations 1100 of FIG. 11 returns to block 1102. If the detection circuitry 148 instead determines at block 1106 that the temperature of the surface of the grill 100 is above the temperature threshold, control of the example machine-readable instructions and/or operations 1100 of FIG. 11 proceeds to block 1108.

At block 1108, the control circuitry 146 of the controller 144 of FIG. 1 generates one or more notification(s) (e.g., visible, audible, and/or tactile message(s) or alert(s)) indicating that the grill 100 is warm. In some examples, the control circuitry 146 generates one or more notification(s) that, when presented, is/are intended to expressly inform a user of the grill 100 that the grill 100 is warm. In other examples, the control circuitry 146 generates one or more notification(s) that, when presented, is/are intended to inherently and/or intuitively inform a user of the grill 100 that the grill 100 is warm. Following block 1108, control of the example machine-readable instructions and/or operations 1100 of FIG. 11 proceeds to block 1110.

At block 1110, the control circuitry 146 of the controller 144 of FIG. 1 instructs, commands, signals, and/or otherwise causes the notification(s) indicating that the grill 100 of FIG. 1 is warm to be presented locally and/or remotely. For example, the control circuitry 146 may instruct, command, signal, and/or otherwise cause one or more of the lighting module(s) 132 of the grill 100 of FIG. 1 to locally present one or more of the notification(s) indicating that the grill 100 is warm. As another example, the control circuitry 146 may additionally or alternatively instruct, command, signal, and/or otherwise cause the user interface 134 of the grill 100 of FIG. 1 to locally present (e.g., via one or more of the output device(s) 138 of the user interface 134) one or more of the notification(s) indicating that the grill 100 is warm. As yet another example, the control circuitry 146 may additionally or alternatively instruct, command, signal, and/or otherwise cause the network interface 140 of the grill 100 of FIG. 1 to transmit (e.g., via one or more of the communication device(s) 142 of the network interface 140) one or more of the notification(s) indicating that the grill 100 is warm to one or more of the remote device(s) 154 of FIG. 1 for remote presentation via one or more of the output device(s) of the remote device(s) 154. In some examples, one or more of the notification(s) indicating that the grill 100 is warm may be presented for a predetermined duration (e.g., a predetermined presentation duration, as may be stored in the memory 152 of the grill 100). In other examples, one or more of the notification(s) indicating that the grill 100 is warm may be presented until a countering event (e.g., determining that the grill 100 is no longer warm, receiving a request, command, and/or instruction to terminate the presentation of the notification(s), etc.) occurs. Following block 1110, control of the example machine-readable instructions and/or operations 1100 of FIG. 11 proceeds to block 1112.

At block 1112, the controller 144 of FIG. 1 determines whether to discontinue monitoring the temperature status of the grill 100 of FIG. 1. For example, the controller 144 may determine that a request, command, and/or instruction to discontinue monitoring the temperature status of the grill 100 has been received based on a user input, a user selection, and/or a user interaction (e.g., a press, a push, a pull, a rotation, a click, a flip, a swipe, a touch, etc.) of, to, and/or with one or more of the input device(s) 136 (e.g., a button, a dial, a knob, a switch, a touchscreen, etc.) of the user interface 134 of FIG. 1. As another example, the controller 144 may determine that a request, command, and/or instruction to discontinue monitoring the temperature status of the grill 100 has been received based on a user input, a user selection, and/or a user interaction (e.g., a press, a push, a pull, a rotation, a click, a flip, a swipe, a touch, etc.) of, to, and/or with one or more input device(s) (e.g., a button, a dial, a knob, a switch, a touchscreen, etc.) of one of the remote device(s) 154 of FIG. 1, as received and/or detected via the network interface 140 of FIG. 1. If the controller 144 determines at block 1112 that the monitoring of the temperature status of the grill 100 is to be continued, control of the machine-readable instructions and/or operations 1100 of FIG. 11 returns to block 1102. If the controller 144 instead determines at block 1112 that the monitoring of the temperature status of the grill 100 is to be discontinued, the machine-readable instructions and/or operations 1100 of FIG. 11 end.

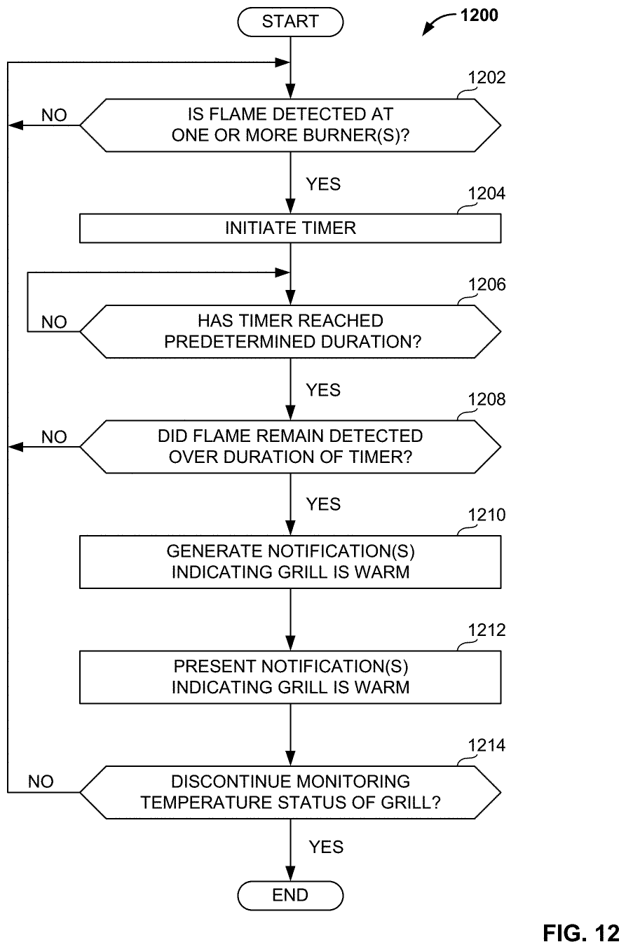

FIG. 12 is a flowchart representative of example machine-readable instructions and/or example operations 1200 that may be executed by processor circuitry to implement a third safety-based temperature status monitoring process of the grill 100 of FIG. 1. The machine-readable instructions and/or operations 1200 of FIG. 12 begin at block 1202 when the detection circuitry 148 of the controller 144 of FIG. 1 determines whether a flame is detected at one or more burner(s) of the grill 100. For example, the detection circuitry 148 may determine whether a flame is detected at the first burner 102 and/or at the second burner 104 of the grill 100 based on data, information, and/or signals sensed, measured, and/or detected by the flame sensor(s) 130 of the grill 100. If the detection circuitry 148 determines at block 1202 that a flame is not detected at one or more of the burner(s) of the grill 100, control of the machine-readable instructions and/or operations 1200 of FIG. 12 remains at block 1202. If the detection circuitry 148 instead determines at block 1202 that a flame is detected at one or more of the burner(s) of the grill 100, control of the machine-readable instructions and/or operations 1200 of FIG. 12 proceeds to block 1204.

At block 1204, the timer circuitry 150 of the controller 144 of FIG. 1 initiates a timer having a predetermined duration (e.g., as may be stored in the memory 152 of the grill 100) associated therewith. In some examples, the predetermined duration of the timer may have an associated starting time value of zero and an associated ending time value greater than zero (e.g., a timer that increases in value over time). In other examples, the predetermined duration of the timer may have an associated starting time value greater than zero and an associated ending time value of zero (e.g., a timer that decreases in value over time). Following block 1204, control of the example machine-readable instructions and/or operations 1200 of FIG. 12 proceeds to block 1206.

At block 1206, the timer circuitry 150 of the controller 144 of FIG. 1 determines whether the timer has reached the predetermined duration. If the timer circuitry 150 determines at block 1206 that the timer has not reached the predetermined duration, control of the machine-readable instructions and/or operations 1200 of FIG. 12 remains at block 1206. If the timer circuitry 150 instead determines at block 1206 that the timer has reached the predetermined duration, control of the machine-readable instructions and/or operations 1200 of FIG. 12 proceeds to block 1208.

At block 1208, the detection circuitry 148 of the controller 144 of FIG. 1 determines whether the flame (e.g., as detected at block 1202) remained detected over the predetermined duration of the timer. For example, the detection circuitry 148 may determine that the flame remained detected based on data, information, and/or signals sensed, measured, and/or detected by the flame sensor(s) 130 of the grill 100 at one or more interval(s) during the predetermined duration of the timer (e.g., at the end time of the predetermined duration, and/or at one or more time(s) between the start time and the end time of the predetermined duration). If the detection circuitry 148 determines at block 1208 that the flame did not remain detected over the predetermined duration of the timer, control of the machine-readable instructions and/or operations 1200 of FIG. 12 returns to block 1202. If the detection circuitry 148 instead determines at block 1208 that the flame remained detected over the predetermined duration of the timer, control of the machine-readable instructions and/or operations 1200 of FIG. 12 proceeds to block 1210.

At block 1210, the control circuitry 146 of the controller 144 of FIG. 1 generates one or more notification(s) (e.g., visible, audible, and/or tactile message(s) or alert(s)) indicating that the grill 100 is warm. In some examples, the control circuitry 146 generates one or more notification(s) that, when presented, is/are intended to expressly inform a user of the grill 100 that the grill 100 is warm. In other examples, the control circuitry 146 generates one or more notification(s) that, when presented, is/are intended to inherently and/or intuitively inform a user of the grill 100 that the grill 100 is warm. Following block 1210, control of the example machine-readable instructions and/or operations 1200 of FIG. 12 proceeds to block 1212.

At block 1212, the control circuitry 146 of the controller 144 of FIG. 1 instructs, commands, signals, and/or otherwise causes the notification(s) indicating that the grill 100 of FIG. 1 is warm to be presented locally and/or remotely. For example, the control circuitry 146 may instruct, command, signal, and/or otherwise cause one or more of the lighting module(s) 132 of the grill 100 of FIG. 1 to locally present one or more of the notification(s) indicating that the grill 100 is warm. As another example, the control circuitry 146 may additionally or alternatively instruct, command, signal, and/or otherwise cause the user interface 134 of the grill 100 of FIG. 1 to locally present (e.g., via one or more of the output device(s) 138 of the user interface 134) one or more of the notification(s) indicating that the grill 100 is warm. As yet another example, the control circuitry 146 may additionally or alternatively instruct, command, signal, and/or otherwise cause the network interface 140 of the grill 100 of FIG. 1 to transmit (e.g., via one or more of the communication device(s) 142 of the network interface 140) one or more of the notification(s) indicating that the grill 100 is warm to one or more of the remote device(s) 154 of FIG. 1 for remote presentation via one or more of the output device(s) of the remote device(s) 154. In some examples, one or more of the notification(s) indicating that the grill 100 is warm may be presented for a predetermined duration (e.g., a predetermined presentation duration, as may be stored in the memory 152 of the grill 100). In other examples, one or more of the notification(s) indicating that the grill 100 is warm may be presented until a countering event (e.g., determining that the grill 100 is no longer warm, receiving a request, command, and/or instruction to terminate the presentation of the notification(s), etc.) occurs. Following block 1212, control of the example machine-readable instructions and/or operations 1200 of FIG. 12 proceeds to block 1214.

At block 1214, the controller 144 of FIG. 1 determines whether to discontinue monitoring the temperature status of the grill 100 of FIG. 1. For example, the controller 144 may determine that a request, command, and/or instruction to discontinue monitoring the temperature status of the grill 100 has been received based on a user input, a user selection, and/or a user interaction (e.g., a press, a push, a pull, a rotation, a click, a flip, a swipe, a touch, etc.) of, to, and/or with one or more of the input device(s) 136 (e.g., a button, a dial, a knob, a switch, a touchscreen, etc.) of the user interface 134 of FIG. 1. As another example, the controller 144 may determine that a request, command, and/or instruction to discontinue monitoring the temperature status of the grill 100 has been received based on a user input, a user selection, and/or a user interaction (e.g., a press, a push, a pull, a rotation, a click, a flip, a swipe, a touch, etc.) of, to, and/or with one or more input device(s) (e.g., a button, a dial, a knob, a switch, a touchscreen, etc.) of one of the remote device(s) 154 of FIG. 1, as received and/or detected via the network interface 140 of FIG. 1. If the controller 144 determines at block 1214 that the monitoring of the temperature status of the grill 100 is to be continued, control of the machine-readable instructions and/or operations 1200 of FIG. 12 returns to block 1202. If the controller 144 instead determines at block 1214 that the monitoring of the temperature status of the grill 100 is to be discontinued, the machine-readable instructions and/or operations 1200 of FIG. 12 end.

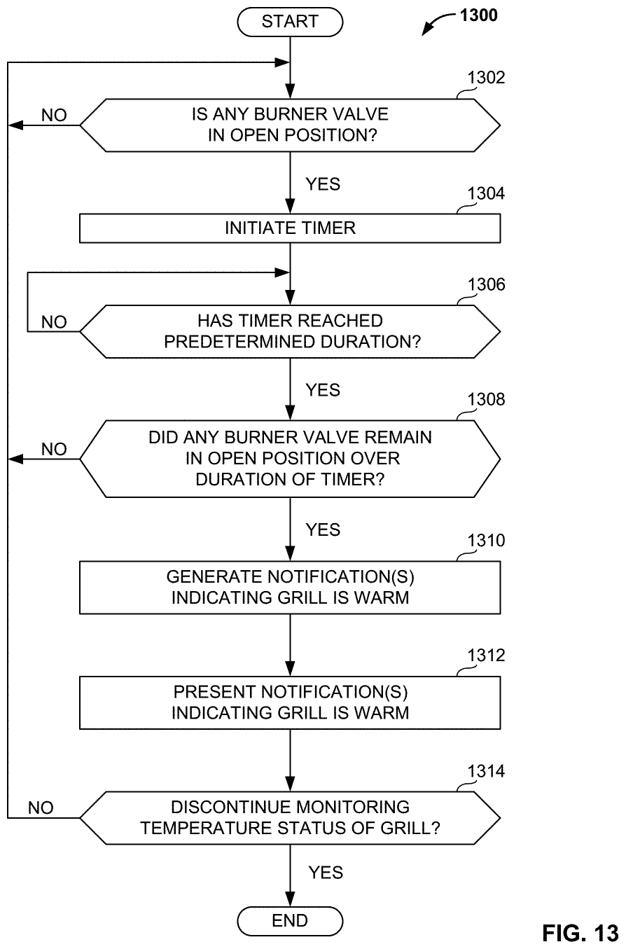

FIG. 13 is a flowchart representative of example machine-readable instructions and/or example operations 1300 that may be executed by processor circuitry to implement a fourth safety-based temperature status monitoring process of the grill 100 of FIG. 1. The machine-readable instructions and/or operations 1300 of FIG. 13 begin at block 1302 when the detection circuitry 148 of the controller 144 of FIG. 1 determines whether any burner valve of the grill 100 is in an open position. For example, the detection circuitry 148 may determine whether that the first burner valve 112 and/or the second burner valve 114 is in a partially-open or fully-open position based on one or more instruction(s), command(s), and/or signal(s) generated at the control circuitry 146 of the controller 144 and/or transmitted to the first burner valve 112 and/or the second burner valve 114. If the detection circuitry 148 determines at block 1302 that no burner valve of the grill 100 is in an open position, control of the machine-readable instructions and/or operations 1300 of FIG. 13 remains at block 1302. If the detection circuitry 148 instead determines at block 1302 that one or more burner valve(s) of the grill 100 is/are in an open position, control of the machine-readable instructions and/or operations 1300 of FIG. 13 proceeds to block 1304.

At block 1304, the timer circuitry 150 of the controller 144 of FIG. 1 initiates a timer having a predetermined duration (e.g., as may be stored in the memory 152 of the grill 100) associated therewith. In some examples, the predetermined duration of the timer may have an associated starting time value of zero and an associated ending time value greater than zero (e.g., a timer that increases in value over time). In other examples, the predetermined duration of the timer may have an associated starting time value greater than zero and an associated ending time value of zero (e.g., a timer that decreases in value over time). Following block 1304, control of the example machine-readable instructions and/or operations 1300 of FIG. 13 proceeds to block 1306.

At block 1306, the timer circuitry 150 of the controller 144 of FIG. 1 determines whether the timer has reached the predetermined duration. If the timer circuitry 150 determines at block 1306 that the timer has not reached the predetermined duration, control of the machine-readable instructions and/or operations 1300 of FIG. 13 remains at block 1306. If the timer circuitry 150 instead determines at block 1306 that the timer has reached the predetermined duration, control of the machine-readable instructions and/or operations 1300 of FIG. 13 proceeds to block 1308.

At block 1308, the detection circuitry 148 of the controller 144 of FIG. 1 determines whether any burner valve of the grill 100 remained in an open position over the predetermined duration of the timer. For example, the detection circuitry 148 may determine that the first burner valve 112 and/or the second burner valve 114 of the grill 100 remained in the open position based on one or more instruction(s), command(s), and/or signal(s) generated at the control circuitry 146 of the controller 144 and/or transmitted to the first burner valve 112 and/or the second burner valve 114 at one or more interval(s) during the predetermined duration of the timer (e.g., at the end time of the predetermined duration, and/or at one or more time(s) between the start time and the end time of the predetermined duration). If the detection circuitry 148 determines at block 1308 that no burner valve of the grill 100 remained in an open position over the predetermined duration of the timer, control of the machine-readable instructions and/or operations 1300 of FIG. 13 returns to block 1302. If the detection circuitry 148 instead determines at block 1308 that one or more of the burner valve(s) of the grill 100 remained in an open position over the predetermined duration of the timer, control of the machine-readable instructions and/or operations 1300 of FIG. 13 proceeds to block 1310.

At block 1310, the control circuitry 146 of the controller 144 of FIG. 1 generates one or more notification(s) (e.g., visible, audible, and/or tactile message(s) or alert(s)) indicating that the grill 100 is warm. In some examples, the control circuitry 146 generates one or more notification(s) that, when presented, is/are intended to expressly inform a user of the grill 100 that the grill 100 is warm. In other examples, the control circuitry 146 generates one or more notification(s) that, when presented, is/are intended to inherently and/or intuitively inform a user of the grill 100 that the grill 100 is warm. Following block 1310, control of the example machine-readable instructions and/or operations 1300 of FIG. 13 proceeds to block 1312.

At block 1312, the control circuitry 146 of the controller 144 of FIG. 1 instructs, commands, signals, and/or otherwise causes the notification(s) indicating that the grill 100 of FIG. 1 is warm to be presented locally and/or remotely. For example, the control circuitry 146 may instruct, command, signal, and/or otherwise cause one or more of the lighting module(s) 132 of the grill 100 of FIG. 1 to locally present one or more of the notification(s) indicating that the grill 100 is warm. As another example, the control circuitry 146 may additionally or alternatively instruct, command, signal, and/or otherwise cause the user interface 134 of the grill 100 of FIG. 1 to locally present (e.g., via one or more of the output device(s) 138 of the user interface 134) one or more of the notification(s) indicating that the grill 100 is warm. As yet another example, the control circuitry 146 may additionally or alternatively instruct, command, signal, and/or otherwise cause the network interface 140 of the grill 100 of FIG. 1 to transmit (e.g., via one or more of the communication device(s) 142 of the network interface 140) one or more of the notification(s) indicating that the grill 100 is warm to one or more of the remote device(s) 154 of FIG. 1 for remote presentation via one or more of the output device(s) of the remote device(s) 154. In some examples, one or more of the notification(s) indicating that the grill 100 is warm may be presented for a predetermined duration (e.g., a predetermined presentation duration, as may be stored in the memory 152 of the grill 100). In other examples, one or more of the notification(s) indicating that the grill 100 is warm may be presented until a countering event (e.g., determining that the grill 100 is no longer warm, receiving a request, command, and/or instruction to terminate the presentation of the notification(s), etc.) occurs. Following block 1312, control of the example machine-readable instructions and/or operations 1300 of FIG. 13 proceeds to block 1314.

At block 1314, the controller 144 of FIG. 1 determines whether to discontinue monitoring the temperature status of the grill 100 of FIG. 1. For example, the controller 144 may determine that a request, command, and/or instruction to discontinue monitoring the temperature status of the grill 100 has been received based on a user input, a user selection, and/or a user interaction (e.g., a press, a push, a pull, a rotation, a click, a flip, a swipe, a touch, etc.) of, to, and/or with one or more of the input device(s) 136 (e.g., a button, a dial, a knob, a switch, a touchscreen, etc.) of the user interface 134 of FIG. 1. As another example, the controller 144 may determine that a request, command, and/or instruction to discontinue monitoring the temperature status of the grill 100 has been received based on a user input, a user selection, and/or a user interaction (e.g., a press, a push, a pull, a rotation, a click, a flip, a swipe, a touch, etc.) of, to, and/or with one or more input device(s) (e.g., a button, a dial, a knob, a switch, a touchscreen, etc.) of one of the remote device(s) 154 of FIG. 1, as received and/or detected via the network interface 140 of FIG. 1. If the controller 144 determines at block 1314 that the monitoring of the temperature status of the grill 100 is to be continued, control of the machine-readable instructions and/or operations 1300 of FIG. 13 returns to block 1302. If the controller 144 instead determines at block 1314 that the monitoring of the temperature status of the grill 100 is to be discontinued, the machine-readable instructions and/or operations 1300 of FIG. 13 end.

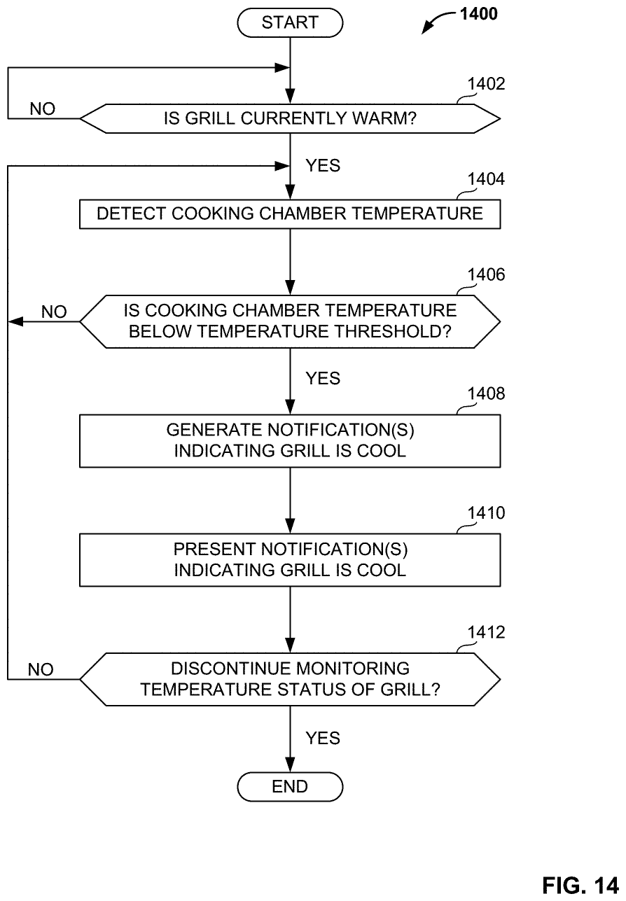

FIG. 14 is a flowchart representative of example machine-readable instructions and/or example operations 1400 that may be executed by processor circuitry to implement a fifth safety-based temperature status monitoring process of the grill 100 of FIG. 1. The machine-readable instructions and/or operations 1400 of FIG. 14 begin at block 1402 when the detection circuitry 148 of the controller 144 of FIG. 1 determines whether the grill 100 of FIG. 1 is currently warm. For example, the detection circuitry 148 may determine whether the grill 100 is currently warm by implementing and/or executing one or more of the method(s), protocol(s), process(es) and/or program(s) described above in connection with FIGS. 10-13. If the detection circuitry 148 determines at block 1402 that the grill 100 is not currently warm, control of the example machine-readable instructions and/or operations 1400 of FIG. 14 remains at block 1402. If the detection circuitry 148 instead determines at block 1402 that the grill 100 is currently warm, control of the example machine-readable instructions and/or operations 1400 of FIG. 14 proceeds to block 1404.

At block 1404, the detection circuitry 148 of the controller 144 of FIG. 1 detects the temperature of the cooking chamber 302 of the grill 100. For example, the detection circuitry 148 may detect (e.g., continuously, or periodically) the temperature of the cooking chamber 302 of the grill 100 based on data, information, and/or signals sensed, measured, and/or detected by the temperature sensor 128 of the grill 100. Following block 1404, control of the example machine-readable instructions and/or operations 1400 of FIG. 14 proceeds to block 1406.

At block 1406, the detection circuitry 148 of the controller 144 of FIG. 1 determines whether the temperature of the cooking chamber 302 of the grill 100 is below a temperature threshold. For example, the detection circuitry 148 may compare the temperature of the cooking chamber 302 of the grill 100 (e.g., as detected at block 1404) to a predetermined temperature threshold (e.g., as may be stored in the memory 152 of the grill 100) that corresponds to the grill 100 being cool (e.g., cold). If the detection circuitry 148 determines at block 1406 that the temperature of the cooking chamber 302 of the grill 100 is not below the temperature threshold, control of the example machine-readable instructions and/or operations 1400 of FIG. 14 returns to block 1404. If the detection circuitry 148 instead determines at block 1406 that the temperature of the cooking chamber 302 of the grill 100 is below the temperature threshold, control of the example machine-readable instructions and/or operations 1400 of FIG. 14 proceeds to block 1408.

At block 1408, the control circuitry 146 of the controller 144 of FIG. 1 generates one or more notification(s) (e.g., visible, audible, and/or tactile message(s) or alert(s)) indicating that the grill 100 is cool. In some examples, the control circuitry 146 generates one or more notification(s) that, when presented, is intended to expressly inform a user of the grill 100 that the grill 100 is cool. In other examples, the control circuitry 146 generates one or more notification(s) that, when presented, is intended to inherently and/or intuitively inform a user of the grill 100 that the grill 100 is cool. Following block 1408, control of the example machine-readable instructions and/or operations 1400 of FIG. 14 proceeds to block 1410.

At block 1410, the control circuitry 146 of the controller 144 of FIG. 1 instructs, commands, signals, and/or otherwise causes the notification(s) indicating that the grill 100 of FIG. 1 is cool to be presented locally and/or remotely. For example, the control circuitry 146 may instruct, command, signal, and/or otherwise cause one or more of the lighting module(s) 132 of the grill 100 of FIG. 1 to locally present one or more of the notification(s) indicating that the grill 100 is cool. As another example, the control circuitry 146 may additionally or alternatively instruct, command, signal, and/or otherwise cause the user interface 134 of the grill 100 of FIG. 1 to locally present (e.g., via one or more of the output device(s) 138 of the user interface 134) one or more of the notification(s) indicating that the grill 100 is cool. As yet another example, the control circuitry 146 may additionally or alternatively instruct, command, signal, and/or otherwise cause the network interface 140 of the grill 100 of FIG. 1 to transmit (e.g., via one or more of the communication device(s) 142 of the network interface 140) one or more of the notification(s) indicating that the grill 100 is cool to one or more of the remote device(s) 154 of FIG. 1 for remote presentation via one or more of the output device(s) of the remote device(s) 154. In some examples, one or more of the notification(s) indicating that the grill 100 is cool may be presented for a predetermined duration (e.g., a predetermined presentation duration, as may be stored in the memory 152 of the grill 100). In other examples, one or more of the notification(s) indicating that the grill 100 is cool may be presented until a countering event (e.g., determining that the grill 100 is no longer cool, receiving a request, command, and/or instruction to terminate the presentation of the notification(s), etc.) occurs. Following block 1410, control of the example machine-readable instructions and/or operations 1400 of FIG. 14 proceeds to block 1412.

At block 1412, the controller 144 of FIG. 1 determines whether to discontinue monitoring the temperature status of the grill 100 of FIG. 1. For example, the controller 144 may determine that a request, command, and/or instruction to discontinue monitoring the temperature status of the grill 100 has been received based on a user input, a user selection, and/or a user interaction (e.g., a press, a push, a pull, a rotation, a click, a flip, a swipe, a touch, etc.) of, to, and/or with one or more of the input device(s) 136 (e.g., a button, a dial, a knob, a switch, a touchscreen, etc.) of the user interface 134 of FIG. 1. As another example, the controller 144 may determine that a request, command, and/or instruction to discontinue monitoring the temperature status of the grill 100 has been received based on a user input, a user selection, and/or a user interaction (e.g., a press, a push, a pull, a rotation, a click, a flip, a swipe, a touch, etc.) of, to, and/or with one or more input device(s) (e.g., a button, a dial, a knob, a switch, a touchscreen, etc.) of one of the remote device(s) 154 of FIG. 1, as received and/or detected via the network interface 140 of FIG. 1. If the controller 144 determines at block 1412 that the monitoring of the temperature status of the grill 100 is to be continued, control of the machine-readable instructions and/or operations 1400 of FIG. 14 returns to block 1404. If the controller 144 instead determines at block 1412 that the monitoring of the temperature status of the grill 100 is to be discontinued, the machine-readable instructions and/or operations 1400 of FIG. 14 end.

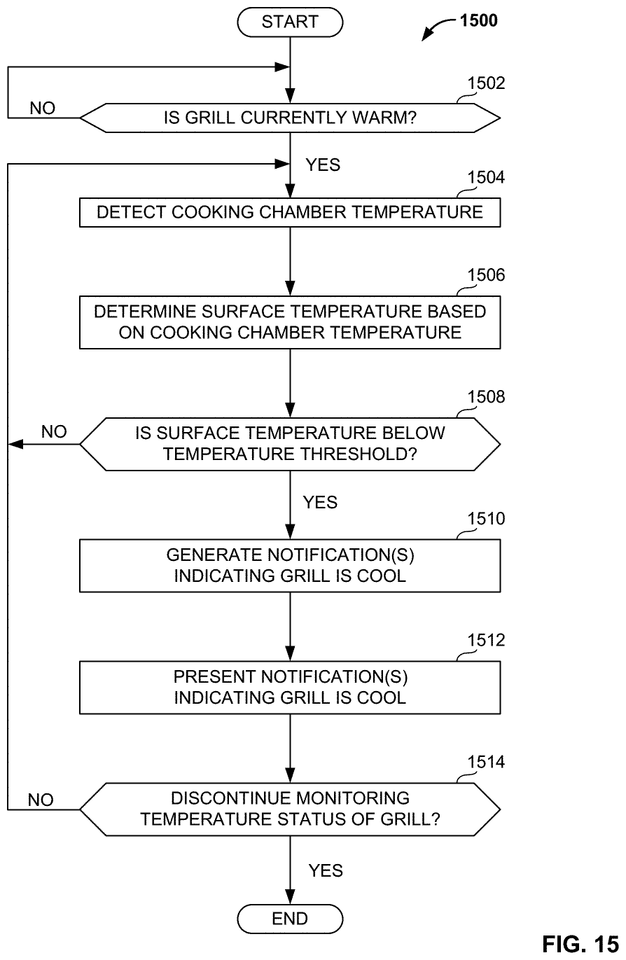

FIG. 15 is a flowchart representative of example machine-readable instructions and/or example operations 1500 that may be executed by processor circuitry to implement a sixth safety-based temperature status monitoring process of the grill 100 of FIG. 1. The machine-readable instructions and/or operations 1500 of FIG. 15 begin at block 1502 when the detection circuitry 148 of the controller 144 of FIG. 1 determines whether the grill 100 of FIG. 1 is currently warm. For example, the detection circuitry 148 may determine whether the grill 100 is currently warm by implementing and/or executing one or more of the method(s), protocol(s), process(es) and/or program(s) described above in connection with FIGS. 10-13. If the detection circuitry 148 determines at block 1502 that the grill 100 is not currently warm, control of the example machine-readable instructions and/or operations 1500 of FIG. 15 remains at block 1502. If the detection circuitry 148 instead determines at block 1502 that the grill 100 is currently warm, control of the example machine-readable instructions and/or operations 1500 of FIG. 15 proceeds to block 1504.

At block 1504 when the detection circuitry 148 of the controller 144 of FIG. 1 detects the temperature of the cooking chamber 302 of the grill 100. For example, the detection circuitry 148 may detect (e.g., continuously, or periodically) the temperature of the cooking chamber 302 of the grill 100 based on data, information, and/or signals sensed, measured, and/or detected by the temperature sensor 128 of the grill 100. Following block 1504, control of the example machine-readable instructions and/or operations 1500 of FIG. 15 proceeds to block 1506.

At block 1506, the detection circuitry 148 of the controller of FIG. 1 determines a temperature of a surface (e.g., a user-contactable, external surface) of the grill 100 based on the temperature of the cooking chamber 302 of the grill 100. For example, the detection circuitry 148 may determine the temperature of the surface of the grill 100 by accessing a temperature correlation table (e.g., as may be stored in the memory 152 of the grill 100) that defines one or more relationship(s) between the temperature of the cooking chamber 302 of the grill 100 and the temperature of the surface of the grill 100 (e.g., the temperature of the surface is Y degrees Fahrenheit when the temperature of the cooking chamber 302 is X degrees Fahrenheit). Following block 1506, control of the example machine-readable instructions and/or operations 1500 of FIG. 15 proceeds to block 1508.

At block 1508, the detection circuitry 148 of the controller 144 of FIG. 1 determines whether the temperature of the surface of the grill 100 is above a temperature threshold. For example, the detection circuitry 148 may compare the temperature of the surface of the grill 100 (e.g., as detected at block 1506) to a predetermined temperature threshold (e.g., as may be stored in the memory 152 of the grill 100) that corresponds to the grill 100 being cool (e.g., cold). If the detection circuitry 148 determines at block 1508 that the temperature of the surface of the grill 100 is not below the temperature threshold, control of the example machine-readable instructions and/or operations 1500 of FIG. 15 returns to block 1504. If the detection circuitry 148 instead determines at block 1508 that the temperature of the surface of the grill 100 is below the temperature threshold, control of the example machine-readable instructions and/or operations 1500 of FIG. 15 proceeds to block 1510.

At block 1510, the control circuitry 146 of the controller 144 of FIG. 1 generates one or more notification(s) (e.g., visible, audible, and/or tactile message(s) or alert(s)) indicating that the grill 100 is cool. In some examples, the control circuitry 146 generates one or more notification(s) that, when presented, is/are intended to expressly inform a user of the grill 100 that the grill 100 is cool. In other examples, the control circuitry 146 generates one or more notification(s) that, when presented, is/are intended to inherently and/or intuitively inform a user of the grill 100 that the grill 100 is cool. Following block 1510, control of the example machine-readable instructions and/or operations 1500 of FIG. 15 proceeds to block 1512.

At block 1512, the control circuitry 146 of the controller 144 of FIG. 1 instructs, commands, signals, and/or otherwise causes the notification(s) indicating that the grill 100 of FIG. 1 is cool to be presented locally and/or remotely. For example, the control circuitry 146 may instruct, command, signal, and/or otherwise cause one or more of the lighting module(s) 132 of the grill 100 of FIG. 1 to locally present one or more of the notification(s) indicating that the grill 100 is cool. As another example, the control circuitry 146 may additionally or alternatively instruct, command, signal, and/or otherwise cause the user interface 134 of the grill 100 of FIG. 1 to locally present (e.g., via one or more of the output device(s) 138 of the user interface 134) one or more of the notification(s) indicating that the grill 100 is cool. As yet another example, the control circuitry 146 may additionally or alternatively instruct, command, signal, and/or otherwise cause the network interface 140 of the grill 100 of FIG. 1 to transmit (e.g., via one or more of the communication device(s) 142 of the network interface 140) one or more of the notification(s) indicating that the grill 100 is cool to one or more of the remote device(s) 154 of FIG. 1 for remote presentation via one or more of the output device(s) of the remote device(s) 154. In some examples, one or more of the notification(s) indicating that the grill 100 is cool may be presented for a predetermined duration (e.g., a predetermined presentation duration, as may be stored in the memory 152 of the grill 100). In other examples, one or more of the notification(s) indicating that the grill 100 is cool may be presented until a countering event (e.g., determining that the grill 100 is no longer cool, receiving a request, command, and/or instruction to terminate the presentation of the notification(s), etc.) occurs. Following block 1512, control of the example machine-readable instructions and/or operations 1500 of FIG. 15 proceeds to block 1514.

At block 1514, the controller 144 of FIG. 1 determines whether to discontinue monitoring the temperature status of the grill 100 of FIG. 1. For example, the controller 144 may determine that a request, command, and/or instruction to discontinue monitoring the temperature status of the grill 100 has been received based on a user input, a user selection, and/or a user interaction (e.g., a press, a push, a pull, a rotation, a click, a flip, a swipe, a touch, etc.) of, to, and/or with one or more of the input device(s) 136 (e.g., a button, a dial, a knob, a switch, a touchscreen, etc.) of the user interface 134 of FIG. 1. As another example, the controller 144 may determine that a request, command, and/or instruction to discontinue monitoring the temperature status of the grill 100 has been received based on a user input, a user selection, and/or a user interaction (e.g., a press, a push, a pull, a rotation, a click, a flip, a swipe, a touch, etc.) of, to, and/or with one or more input device(s) (e.g., a button, a dial, a knob, a switch, a touchscreen, etc.) of one of the remote device(s) 154 of FIG. 1, as received and/or detected via the network interface 140 of FIG. 1. If the controller 144 determines at block 1514 that the monitoring of the temperature status of the grill 100 is to be continued, control of the machine-readable instructions and/or operations 1500 of FIG. 15 returns to block 1504. If the controller 144 instead determines at block 1514 that the monitoring of the temperature status of the grill 100 is to be discontinued, the machine-readable instructions and/or operations 1500 of FIG. 15 end.

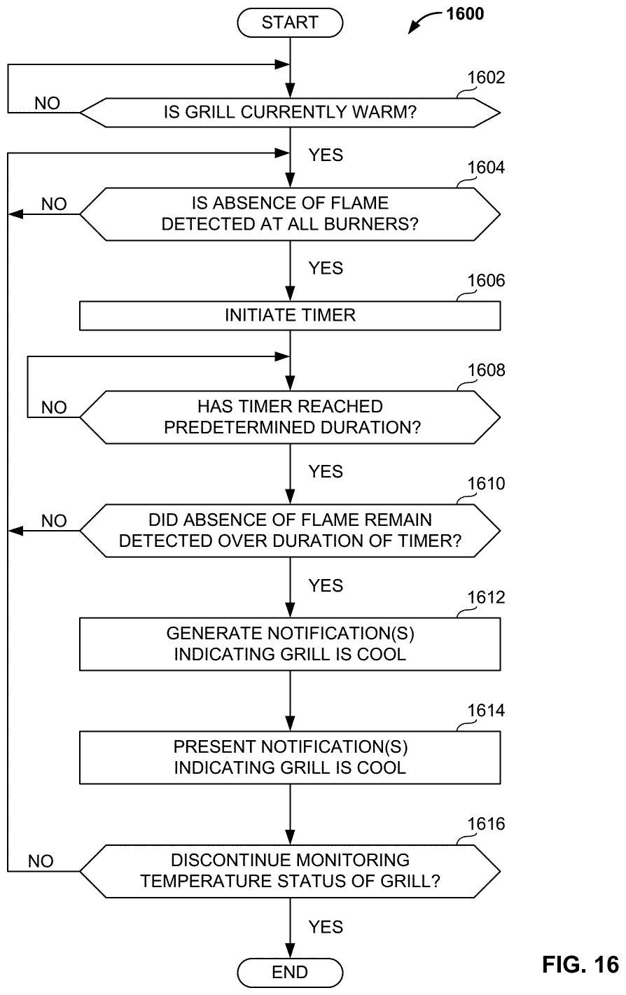

FIG. 16 is a flowchart representative of example machine-readable instructions and/or example operations 1600 that may be executed by processor circuitry to implement a seventh safety-based temperature status monitoring process of the grill 100 of FIG. 1. The machine-readable instructions and/or operations 1600 of FIG. 16 begin at block 1602 when the detection circuitry 148 of the controller 144 of FIG. 1 determines whether the grill 100 of FIG. 1 is currently warm. For example, the detection circuitry 148 may determine whether the grill 100 is currently warm by implementing and/or executing one or more of the method(s), protocol(s), process(es) and/or program(s) described above in connection with FIGS. 10-13. If the detection circuitry 148 determines at block 1602 that the grill 100 is not currently warm, control of the example machine-readable instructions and/or operations 1600 of FIG. 16 remains at block 1602. If the detection circuitry 148 instead determines at block 1602 that the grill 100 is currently warm, control of the example machine-readable instructions and/or operations 1600 of FIG. 16 proceeds to block 1604.

At block 1604, the detection circuitry 148 of the controller 144 of FIG. 1 determines whether an absence of a flame is detected at all of the burners of the grill 100. For example, the detection circuitry 148 may determine whether an absence of a flame is detected at the first burner 102 and the second burner 104 of the grill 100 based on data, information, and/or signals sensed, measured, and/or detected by the flame sensor(s) 130 of the grill 100. If the detection circuitry 148 determines at block 1604 that an absence of a flame is not detected at all of the burners of the grill 100, control of the machine-readable instructions and/or operations 1600 of FIG. 16 remains at block 1604. If the detection circuitry 148 instead determines at block 1604 that an absence of a flame is detected at all of the burners of the grill 100, control of the machine-readable instructions and/or operations 1600 of FIG. 16 proceeds to block 1606.

At block 1606, the timer circuitry 150 of the controller 144 of FIG. 1 initiates a timer having a predetermined duration (e.g., as may be stored in the memory 152 of the grill 100) associated therewith. In some examples, the predetermined duration of the timer may have an associated starting time value of zero and an associated ending time value greater than zero (e.g., a timer that increases in value over time). In other examples, the predetermined duration of the timer may have an associated starting time value greater than zero and an associated ending time value of zero (e.g., a timer that decreases in value over time). Following block 1606, control of the example machine-readable instructions and/or operations 1600 of FIG. 16 proceeds to block 1608.

At block 1608, the timer circuitry 150 of the controller 144 of FIG. 1 determines whether the timer has reached the predetermined duration. If the timer circuitry 150 determines at block 1608 that the timer has not reached the predetermined duration, control of the machine-readable instructions and/or operations 1600 of FIG. 16 remains at block 1610. If the timer circuitry 150 instead determines at block 1608 that the timer has reached the predetermined duration, control of the machine-readable instructions and/or operations 1600 of FIG. 16 proceeds to block 1610.

At block 1610, the detection circuitry 148 of the controller 144 of FIG. 1 determines whether the absence of the flame (e.g., as detected at block 1604) remained detected over the predetermined duration of the timer. For example, the detection circuitry 148 may determine that the absence of the flame remained detected based on data, information, and/or signals sensed, measured, and/or detected by the flame sensor(s) 130 of the grill 100 at one or more interval(s) during the predetermined duration of the timer (e.g., at the end time of the predetermined duration, and/or at one or more time(s) between the start time and the end time of the predetermined duration). If the detection circuitry 148 determines at block 1610 that the absence of the flame did not remain detected over the predetermined duration of the timer, control of the machine-readable instructions and/or operations 1600 of FIG. 16 returns to block 1604. If the detection circuitry 148 instead determines at block 1610 that the absence of the flame remained detected over the predetermined duration of the timer, control of the machine-readable instructions and/or operations 1600 of FIG. 16 proceeds to block 1612.

At block 1612, the control circuitry 146 of the controller 144 of FIG. 1 generates one or more notification(s) (e.g., visible, audible, and/or tactile message(s) or alert(s)) indicating that the grill 100 is cool. In some examples, the control circuitry 146 generates one or more notification(s) that, when presented, is/are intended to expressly inform a user of the grill 100 that the grill 100 is cool. In other examples, the control circuitry 146 generates one or more notification(s) that, when presented, is/are intended to inherently and/or intuitively inform a user of the grill 100 that the grill 100 is cool. Following block 1612, control of the example machine-readable instructions and/or operations 1600 of FIG. 16 proceeds to block 1614.

At block 1614, the control circuitry 146 of the controller 144 of FIG. 1 instructs, commands, signals, and/or otherwise causes the notification(s) indicating that the grill 100 of FIG. 1 is cool to be presented locally and/or remotely. For example, the control circuitry 146 may instruct, command, signal, and/or otherwise cause one or more of the lighting module(s) 132 of the grill 100 of FIG. 1 to locally present one or more of the notification(s) indicating that the grill 100 is cool. As another example, the control circuitry 146 may additionally or alternatively instruct, command, signal, and/or otherwise cause the user interface 134 of the grill 100 of FIG. 1 to locally present (e.g., via one or more of the output device(s) 138 of the user interface 134) one or more of the notification(s) indicating that the grill 100 is cool. As yet another example, the control circuitry 146 may additionally or alternatively instruct, command, signal, and/or otherwise cause the network interface 140 of the grill 100 of FIG. 1 to transmit (e.g., via one or more of the communication device(s) 142 of the network interface 140) one or more of the notification(s) indicating that the grill 100 is cool to one or more of the remote device(s) 154 of FIG. 1 for remote presentation via one or more of the output device(s) of the remote device(s) 154. In some examples, one or more of the notification(s) indicating that the grill 100 is cool may be presented for a predetermined duration (e.g., a predetermined presentation duration, as may be stored in the memory 152 of the grill 100). In other examples, one or more of the notification(s) indicating that the grill 100 is cool may be presented until a countering event (e.g., determining that the grill 100 is no longer cool, receiving a request, command, and/or instruction to terminate the presentation of the notification(s), etc.) occurs. Following block 1614, control of the example machine-readable instructions and/or operations 1600 of FIG. 16 proceeds to block 1616.

At block 1616, the controller 144 of FIG. 1 determines whether to discontinue monitoring the temperature status of the grill 100 of FIG. 1. For example, the controller 144 may determine that a request, command, and/or instruction to discontinue monitoring the temperature status of the grill 100 has been received based on a user input, a user selection, and/or a user interaction (e.g., a press, a push, a pull, a rotation, a click, a flip, a swipe, a touch, etc.) of, to, and/or with one or more of the input device(s) 136 (e.g., a button, a dial, a knob, a switch, a touchscreen, etc.) of the user interface 134 of FIG. 1. As another example, the controller 144 may determine that a request, command, and/or instruction to discontinue monitoring the temperature status of the grill 100 has been received based on a user input, a user selection, and/or a user interaction (e.g., a press, a push, a pull, a rotation, a click, a flip, a swipe, a touch, etc.) of, to, and/or with one or more input device(s) (e.g., a button, a dial, a knob, a switch, a touchscreen, etc.) of one of the remote device(s) 154 of FIG. 1, as received and/or detected via the network interface 140 of FIG. 1. If the controller 144 determines at block 1616 that the monitoring of the temperature status of the grill 100 is to be continued, control of the machine-readable instructions and/or operations 1600 of FIG. 16 returns to block 1604. If the controller 144 instead determines at block 1616 that the monitoring of the temperature status of the grill 100 is to be discontinued, the machine-readable instructions and/or operations 1600 of FIG. 16 end.

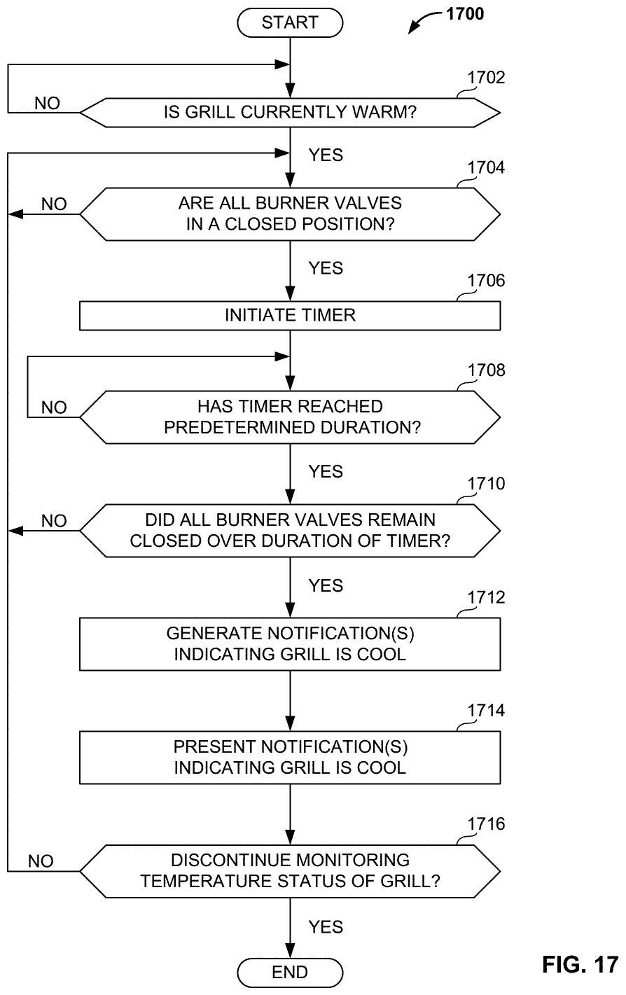

FIG. 17 is a flowchart representative of example machine-readable instructions and/or example operations 1700 that may be executed by processor circuitry to implement an eighth safety-based temperature status monitoring process of the grill 100 of FIG. 1. The machine-readable instructions and/or operations 1700 of FIG. 17 begin at block 1702 when the detection circuitry 148 of the controller 144 of FIG. 1 determines whether the grill 100 of FIG. 1 is currently warm. For example, the detection circuitry 148 may determine whether the grill 100 is currently warm by implementing and/or executing one or more of the method(s), protocol(s), process(es) and/or program(s) described above in connection with FIGS. 10-13. If the detection circuitry 148 determines at block 1702 that the grill 100 is not currently warm, control of the example machine-readable instructions and/or operations 1700 of FIG. 17 remains at block 1702. If the detection circuitry 148 instead determines at block 1702 that the grill 100 is currently warm, control of the example machine-readable instructions and/or operations 1700 of FIG. 17 proceeds to block 1704.

At block 1704, the detection circuitry 148 of the controller 144 of FIG. 1 determines whether all of the burner valves of the grill 100 are in a closed position. For example, the detection circuitry 148 may determine whether that the first burner valve 112 and the second burner valve 114 are in a fully-closed position based on one or more instruction(s), command(s), and/or signal(s) generated at the control circuitry 146 of the controller 144 and/or transmitted to the first burner valve 112 and the second burner valve 114. If the detection circuitry 148 determines at block 1704 that all of the burner valves of the grill 100 are not in a closed position, control of the machine-readable instructions and/or operations 1700 of FIG. 17 remains at block 1704. If the detection circuitry 148 instead determines at block 1704 that all of the burner valves of the grill 100 are in a closed position, control of the machine-readable instructions and/or operations 1700 of FIG. 17 proceeds to block 1706.

At block 1706, the timer circuitry 150 of the controller 144 of FIG. 1 initiates a timer having a predetermined duration (e.g., as may be stored in the memory 152 of the grill 100) associated therewith. In some examples, the predetermined duration of the timer may have an associated starting time value of zero and an associated ending time value greater than zero (e.g., a timer that increases in value over time). In other examples, the predetermined duration of the timer may have an associated starting time value greater than zero and an associated ending time value of zero (e.g., a timer that decreases in value over time). Following block 1706, control of the example machine-readable instructions and/or operations 1700 of FIG. 17 proceeds to block 1708.

At block 1708, the timer circuitry 150 of the controller 144 of FIG. 1 determines whether the timer has reached the predetermined duration. If the timer circuitry 150 determines at block 1708 that the timer has not reached the predetermined duration, control of the machine-readable instructions and/or operations 1700 of FIG. 17 remains at block 1708. If the timer circuitry 150 instead determines at block 1708 that the timer has reached the predetermined duration, control of the machine-readable instructions and/or operations 1700 of FIG. 17 proceeds to block 1710.

At block 1710, the detection circuitry 148 of the controller 144 of FIG. 1 determines whether all of the burner valves of the grill 100 remained in a closed position over the predetermined duration of the timer. For example, the detection circuitry 148 may determine that the first burner valve 112 and the second burner valve 114 of the grill 100 remained in the closed position based on one or more instruction(s), command(s), and/or signal(s) generated at the control circuitry 146 of the controller 144 and/or transmitted to the first burner valve 112 and the second burner valve 114 at one or more interval(s) during the predetermined duration of the timer (e.g., at the end time of the predetermined duration, and/or at one or more time(s) between the start time and the end time of the predetermined duration). If the detection circuitry 148 determines at block 1710 that all of the burner valves of the grill 100 did not remain in a closed position over the predetermined duration of the timer, control of the machine-readable instructions and/or operations 1700 of FIG. 17 returns to block 1704. If the detection circuitry 148 instead determines at block 1710 that all of the burner valves of the grill 100 remained in a closed position over the predetermined duration of the timer, control of the machine-readable instructions and/or operations 1700 of FIG. 17 proceeds to block 1712.

At block 1712, the control circuitry 146 of the controller 144 of FIG. 1 generates one or more notification(s) (e.g., visible, audible, and/or tactile message(s) or alert(s)) indicating that the grill 100 is cool. In some examples, the control circuitry 146 generates one or more notification(s) that, when presented, is/are intended to expressly inform a user of the grill 100 that the grill 100 is cool. In other examples, the control circuitry 146 generates one or more notification(s) that, when presented, is/are intended to inherently and/or intuitively inform a user of the grill 100 that the grill 100 is cool. Following block 1712, control of the example machine-readable instructions and/or operations 1700 of FIG. 17 proceeds to block 1714.

At block 1714, the control circuitry 146 of the controller 144 of FIG. 1 instructs, commands, signals, and/or otherwise causes the notification(s) indicating that the grill 100 of FIG. 1 is cool to be presented locally and/or remotely. For example, the control circuitry 146 may instruct, command, signal, and/or otherwise cause one or more of the lighting module(s) 132 of the grill 100 of FIG. 1 to locally present one or more of the notification(s) indicating that the grill 100 is cool. As another example, the control circuitry 146 may additionally or alternatively instruct, command, signal, and/or otherwise cause the user interface 134 of the grill 100 of FIG. 1 to locally present (e.g., via one or more of the output device(s) 138 of the user interface 134) one or more of the notification(s) indicating that the grill 100 is cool. As yet another example, the control circuitry 146 may additionally or alternatively instruct, command, signal, and/or otherwise cause the network interface 140 of the grill 100 of FIG. 1 to transmit (e.g., via one or more of the communication device(s) 142 of the network interface 140) one or more of the notification(s) indicating that the grill 100 is cool to one or more of the remote device(s) 154 of FIG. 1 for remote presentation via one or more of the output device(s) of the remote device(s) 154. In some examples, one or more of the notification(s) indicating that the grill 100 is cool may be presented for a predetermined duration (e.g., a predetermined presentation duration, as may be stored in the memory 152 of the grill 100). In other examples, one or more of the notification(s) indicating that the grill 100 is cool may be presented until a countering event (e.g., determining that the grill 100 is no longer cool, receiving a request, command, and/or instruction to terminate the presentation of the notification(s), etc.) occurs. Following block 1714, control of the example machine-readable instructions and/or operations 1700 of FIG. 17 proceeds to block 1716.

At block 1716, the controller 144 of FIG. 1 determines whether to discontinue monitoring the temperature status of the grill 100 of FIG. 1. For example, the controller 144 may determine that a request, command, and/or instruction to discontinue monitoring the temperature status of the grill 100 has been received based on a user input, a user selection, and/or a user interaction (e.g., a press, a push, a pull, a rotation, a click, a flip, a swipe, a touch, etc.) of, to, and/or with one or more of the input device(s) 136 (e.g., a button, a dial, a knob, a switch, a touchscreen, etc.) of the user interface 134 of FIG. 1. As another example, the controller 144 may determine that a request, command, and/or instruction to discontinue monitoring the temperature status of the grill 100 has been received based on a user input, a user selection, and/or a user interaction (e.g., a press, a push, a pull, a rotation, a click, a flip, a swipe, a touch, etc.) of, to, and/or with one or more input device(s) (e.g., a button, a dial, a knob, a switch, a touchscreen, etc.) of one of the remote device(s) 154 of FIG. 1, as received and/or detected via the network interface 140 of FIG. 1. If the controller 144 determines at block 1716 that the monitoring of the temperature status of the grill 100 is to be continued, control of the machine-readable instructions and/or operations 1700 of FIG. 17 returns to block 1704. If the controller 144 instead determines at block 1716 that the monitoring of the temperature status of the grill 100 is to be discontinued, the machine-readable instructions and/or operations 1700 of FIG. 17 end.

FIG. 18 is a block diagram of an example processor platform 1800 including processor circuitry structured to execute and/or instantiate the machine-readable instructions and/or operations of FIGS. 10-17 to implement the grill 100 of FIG. 1. The processor platform 1800 of the illustrated example includes processor circuitry 1802. The processor circuitry 1802 of the illustrated example is hardware. For example, the processor circuitry 1802 can be implemented by one or more integrated circuit(s), logic circuit(s), FPGA(s), microprocessor(s), CPU(s), GPU(s), DSP(s), and/or microcontroller(s) from any desired family or manufacturer. The processor circuitry 1802 may be implemented by one or more semiconductor based (e.g., silicon based) device(s). In this example, the processor circuitry 1802 implements the controller 144 of FIG. 1, including the control circuitry 146, the detection circuitry 148, and the timer circuitry 150 of the controller 144.

The processor circuitry 1802 of the illustrated example includes a local memory 1804 (e.g., a cache, registers, etc.). The processor circuitry 1802 is in electrical communication with one or more valve(s) 1806 via a bus 1808. In this example, the valve(s) 1806 include the fuel source valve 108, the first burner valve 112, and the second burner valve 114 of FIG. 1. The processor circuitry 1802 is also in electrical communication with one or more ignitor(s) 1810 via the bus 1808. In this example, the ignitor(s) 1810 include the first ignitor 116 and the second ignitor 118 of FIG. 1. The processor circuitry 1802 is also in electrical communication with one or more sensor(s) 1812 via the bus 1808. In this example, the sensor(s) 1812 include the first encoder 120, the second encoder 124, the temperature sensor 128, and the flame sensor(s) 130 of FIG. 1. The processor circuitry 1802 is also in electrical communication with one or more lighting module(s) 1814 via the bus 1808. In this example, the lighting module(s) 1814 include the lighting module(s) 132 of FIG. 1.

The processor circuitry 1802 is also in electrical communication with a main memory via the bus 1808, with the main memory including a volatile memory 1816 and a non-volatile memory 1818. The volatile memory 1816 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1818 may be implemented by flash memory and/or any other desired type of memory device. Access to the main memory 1816, 1818 of the illustrated example is controlled by a memory controller.

The processor platform 1800 of the illustrated example also includes one or more mass storage device(s) 1820 to store software and/or data. Examples of such mass storage device(s) 1820 include magnetic storage devices, optical storage devices, floppy disk drives, HDDs, CDs, Blu-ray disk drives, redundant array of independent disks (RAID) systems, solid state storage devices such as flash memory devices, and DVD drives. In the illustrated example of FIG. 18, one or more of the volatile memory 1816, the non-volatile memory 1818, and/or the mass storage device(s) 1820 implement(s) the memory 152 of FIG. 1.

The processor platform 1800 of the illustrated example also includes user interface circuitry 1822. The user interface circuitry 1822 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. In the illustrated example, one or more input device(s) 136 are connected to the user interface circuitry 1822. The input device(s) 136 permit(s) a user to enter data and/or commands into the processor circuitry 1802. The input device(s) 136 can be implemented by, for example, one or more button(s), dial(s), knob(s), switch(es), touchscreen(s), audio sensor(s), microphone(s), image sensor(s), and/or camera(s). One or more output device(s) 138 are also connected to the user interface circuitry 1822 of the illustrated example. The output device(s) 138 can be implemented, for example, by one or more display device(s) (e.g., light emitting diode(s) (LED(s)), organic light emitting diode(s) (OLED(s)), liquid crystal display(s) (LCD(s)), cathode ray tube (CRT) display(s), in-place switching (IPS) display(s), touchscreen(s), etc.), tactile output device(s), and/or speaker(s). The user interface circuitry 1822 of the illustrated example, thus, typically includes a graphics driver card, a graphics driver chip, and/or graphics processor circuitry such as a GPU. In the illustrated example of FIG. 18, the user interface circuitry 1822, the input device(s) 136, and the output device(s) 138 collectively implement the user interface 134 of FIG. 1.

The processor platform 1800 of the illustrated example also includes network interface circuitry 1824. The network interface circuitry 1824 includes one or more communication device(s) (e.g., transmitter(s), receiver(s), transceiver(s), modem(s), gateway(s), wireless access point(s), etc.) to facilitate exchange of data with external machines (e.g., computing devices of any kind, including the remote device(s) 154 of FIG. 1) by a network 1826. The communication can be by, for example, an Ethernet connection, a digital subscriber line (DSL) connection, a telephone line connection, a coaxial cable system, a satellite system, a wireless system, a cellular telephone system, an optical connection, etc. In the illustrated example of FIG. 18, the network interface circuitry 1824 implements the network interface 140 (e.g., including the communication device(s) 142) of FIG. 1.

Coded instructions 1828 including the above-described machine-readable instructions and/or operations of FIGS. 10-17 may be stored the local memory 1804, in the volatile memory 1816, in the non-volatile memory 1818, on the mass storage device(s) 1820, and/or on a removable non-transitory computer-readable storage medium such as a flash memory stick, a dongle, a CD, or a DVD.

FIG. 19 is a block diagram of an example implementation of the processor circuitry 1802 of FIG. 18. In this example, the processor circuitry 1802 of FIG. 18 is implemented by a microprocessor 1900. For example, the microprocessor 1900 may implement multi-core hardware circuitry such as a CPU, a DSP, a GPU, an XPU, etc. Although it may include any number of example cores 1902 (e.g., 1 core), the microprocessor 1900 of this example is a multi-core semiconductor device including N cores. The cores 1902 of the microprocessor 1900 may operate independently or may cooperate to execute machine-readable instructions. For example, machine code corresponding to a firmware program, an embedded software program, or a software program may be executed by one of the cores 1902 or may be executed by multiple ones of the cores 1902 at the same or different times. In some examples, the machine code corresponding to the firmware program, the embedded software program, or the software program is split into threads and executed in parallel by two or more of the cores 1902. The software program may correspond to a portion or all of the machine-readable instructions and/or operations represented by the flowcharts of FIGS. 10-17.

The cores 1902 may communicate by an example bus 1904. In some examples, the bus 1904 may implement a communication bus to effectuate communication associated with one(s) of the cores 1902. For example, the bus 1904 may implement at least one of an Inter-Integrated Circuit (I2C) bus, a Serial Peripheral Interface (SPI) bus, a PCI bus, or a PCIe bus. Additionally, or alternatively, the bus 1904 may implement any other type of computing or electrical bus. The cores 1902 may obtain data, instructions, and/or signals from one or more external devices by example interface circuitry 1906. The cores 1902 may output data, instructions, and/or signals to the one or more external devices by the interface circuitry 1906. Although the cores 1902 of this example include example local memory 1920 (e.g., Level 1 (L1) cache that may be split into an L1 data cache and an L1 instruction cache), the microprocessor 1900 also includes example shared memory 1910 that may be shared by the cores (e.g., Level 2 (L2_cache)) for high-speed access to data and/or instructions. Data and/or instructions may be transferred (e.g., shared) by writing to and/or reading from the shared memory 1910. The local memory 1920 of each of the cores 1902 and the shared memory 1910 may be part of a hierarchy of storage devices including multiple levels of cache memory and the main memory (e.g., the main memory 1816, 1818 of FIG. 18). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1902 may be referred to as a CPU, DSP, GPU, etc., or any other type of hardware circuitry. Each core 1902 includes control unit circuitry 1914, arithmetic and logic (AL) circuitry (sometimes referred to as an ALU) 1916, a plurality of registers 1918, the L1 cache 1920, and an example bus 1922. Other structures may be present. For example, each core 1902 may include vector unit circuitry, single instruction multiple data (SIMD) unit circuitry, load/store unit (LSU) circuitry, branch/jump unit circuitry, floating-point unit (FPU) circuitry, etc. The control unit circuitry 1914 includes semiconductor-based circuits structured to control (e.g., coordinate) data movement within the corresponding core 1902. The AL circuitry 1916 includes semiconductor-based circuits structured to perform one or more mathematic and/or logic operations on the data within the corresponding core 1902. The AL circuitry 1916 of some examples performs integer based operations. In other examples, the AL circuitry 1916 also performs floating point operations. In yet other examples, the AL circuitry 1916 may include first AL circuitry that performs integer based operations and second AL circuitry that performs floating point operations. In some examples, the AL circuitry 1916 may be referred to as an Arithmetic Logic Unit (ALU). The registers 1918 are semiconductor-based structures to store data and/or instructions such as results of one or more of the operations performed by the AL circuitry 1916 of the corresponding core 1902. For example, the registers 1918 may include vector register(s), SIMD register(s), general purpose register(s), flag register(s), segment register(s), machine specific register(s), instruction pointer register(s), control register(s), debug register(s), memory management register(s), machine check register(s), etc. The registers 1918 may be arranged in a bank as shown in FIG. 19. Alternatively, the registers 1918 may be organized in any other arrangement, format, or structure including distributed throughout the core 1902 to shorten access time. The bus 1922 may implement at least one of an I2C bus, a SPI bus, a PCI bus, or a PCIe bus.

Each core 1902 and/or, more generally, the microprocessor 1900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)), and/or other circuitry may be present. The microprocessor 1900 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

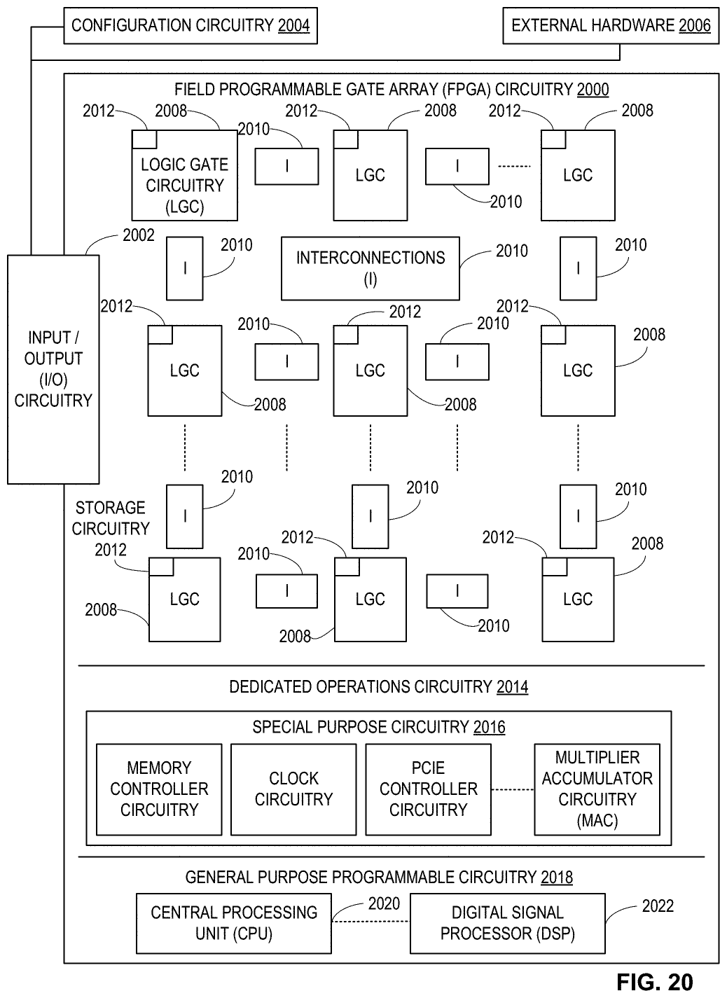

FIG. 20 is a block diagram of another example implementation of the processor circuitry 1802 of FIG. 18. In this example, the processor circuitry 1802 is implemented by FPGA circuitry 2000. The FPGA circuitry 2000 can be used, for example, to perform operations that could otherwise be performed by the example microprocessor 1900 of FIG. 19 executing corresponding machine-readable instructions. However, once configured, the FPGA circuitry 2000 instantiates the machine-readable instructions in hardware and, thus, can often execute the operations faster than they could be performed by a general purpose microprocessor executing the corresponding software.

More specifically, in contrast to the microprocessor 1900 of FIG. 19 described above (which is a general purpose device that may be programmed to execute some or all of the machine-readable instructions and/or operations represented by the flowcharts of FIGS. 10-17, but whose interconnections and logic circuitry are fixed once fabricated), the FPGA circuitry 2000 of the example of FIG. 20 includes interconnections and logic circuitry that may be configured and/or interconnected in different ways after fabrication to instantiate, for example, some or all of the machine-readable instructions and/or operations represented by the flowcharts of FIGS. 10-17. In particular, the FPGA circuitry 2000 may be thought of as an array of logic gates, interconnections, and switches. The switches can be programmed to change how the logic gates are interconnected by the interconnections, effectively forming one or more dedicated logic circuits (unless and until the FPGA circuitry 2000 is reprogrammed). The configured logic circuits enable the logic gates to cooperate in different ways to perform different operations on data received by input circuitry. Those operations may correspond to some or all of the software represented by the flowcharts of FIGS. 10-17. As such, the FPGA circuitry 2000 may be structured to effectively instantiate some or all of the machine-readable instructions of the flowcharts of FIGS. 10-17 as dedicated logic circuits to perform the operations corresponding to those software instructions in a dedicated manner analogous to an ASIC. Therefore, the FPGA circuitry 2000 may perform the operations corresponding to the some or all of the machine-readable instructions of FIGS. 10-17 faster than the general purpose microprocessor can execute the same.

In the example of FIG. 20, the FPGA circuitry 2000 is structured to be programmed (and/or reprogrammed one or more times) by an end user by a hardware description language (HDL) such as Verilog. The FPGA circuitry 2000 of FIG. 20 includes example input/output (I/O) circuitry 2002 to obtain and/or output data to/from example configuration circuitry 2004 and/or external hardware (e.g., external hardware circuitry) 2006. For example, the configuration circuitry 2004 may implement interface circuitry that may obtain machine-readable instructions to configure the FPGA circuitry 2000, or portion(s) thereof. In some such examples, the configuration circuitry 2004 may obtain the machine-readable instructions from a user, a machine (e.g., hardware circuitry (e.g., programmed, or dedicated circuitry) that may implement an Artificial Intelligence/Machine Learning (AI/ML) model to generate the instructions), etc. In some examples, the external hardware 2006 may implement the microprocessor 1900 of FIG. 19. The FPGA circuitry 2000 also includes an array of example logic gate circuitry 2008, a plurality of example configurable interconnections 2010, and example storage circuitry 2012. The logic gate circuitry 2008 and interconnections 2010 are configurable to instantiate one or more operations that may correspond to at least some of the machine-readable instructions of FIGS. 10-17 and/or other desired operations. The logic gate circuitry 2008 shown in FIG. 20 is fabricated in groups or blocks. Each block includes semiconductor-based electrical structures that may be configured into logic circuits. In some examples, the electrical structures include logic gates (e.g., AND gates, OR gates, NOR gates, etc.) that provide basic building blocks for logic circuits. Electrically controllable switches (e.g., transistors) are present within each of the logic gate circuitry 2008 to enable configuration of the electrical structures and/or the logic gates to form circuits to perform desired operations. The logic gate circuitry 2008 may include other electrical structures such as look-up tables (LUTs), registers (e.g., flip-flops or latches), multiplexers, etc.

The interconnections 2010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2008 to program desired logic circuits.

The storage circuitry 2012 of the illustrated example is structured to store result(s) of the one or more of the operations performed by corresponding logic gates. The storage circuitry 2012 may be implemented by registers or the like. In the illustrated example, the storage circuitry 2012 is distributed amongst the logic gate circuitry 2008 to facilitate access and increase execution speed.

The example FPGA circuitry 2000 of FIG. 20 also includes example Dedicated Operations Circuitry 2014. In this example, the Dedicated Operations Circuitry 2014 includes special purpose circuitry 2016 that may be invoked to implement commonly used functions to avoid the need to program those functions in the field. Examples of such special purpose circuitry 2016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2000 may also include example general purpose programmable circuitry 2018 such as an example CPU 2020 and/or an example DSP 2022. Other general purpose programmable circuitry 2018 may additionally or alternatively be present such as a GPU, an XPU, etc., that can be programmed to perform other operations.

Although FIGS. 19 and 20 illustrate two example implementations of the processor circuitry 1802 of FIG. 18, many other approaches are contemplated. For example, as mentioned above, modern FPGA circuitry may include an on-board CPU, such as one or more of the example CPU 2020 of FIG. 20. Therefore, the processor circuitry 1802 of FIG. 18 may additionally be implemented by combining the example microprocessor 1900 of FIG. 19 and the example FPGA circuitry 2000 of FIG. 20. In some such hybrid examples, a first portion of the machine-readable instructions and/or operations represented by the flowcharts of FIGS. 10-17 may be executed by one or more of the cores 1902 of FIG. 19 and a second portion of the machine-readable instructions and/or operations represented by the flowcharts of FIGS. 10-17 may be executed by the FPGA circuitry 2000 of FIG. 20.

In some examples, the processor circuitry 1802 of FIG. 18 may be in one or more packages. For example, the microprocessor 1900 of FIG. 19 and/or the FPGA circuitry 2000 of FIG. 20 may be in one or more packages. In some examples, an XPU may be implemented by the processor circuitry 1802 of FIG. 18, which may be in one or more packages. For example, the XPU may include a CPU in one package, a DSP in another package, a GPU in yet another package, and an FPGA in still yet another package.

From the foregoing, it will be appreciated that the above-disclosed methods and apparatus advantageously present one or more notification(s) indicating that a corresponding one or more safety-based temperature condition(s) of a grill has/have been satisfied. In some disclosed examples, the presented notification intuitively indicates or expressly informs a user of the grill (or other individuals located in the vicinity of the grill) that the grill is too warm (e.g., too hot) to have certain of the grill's exterior surfaces be safely touched and/or contacted by a human. In other disclosed examples, the presented notification intuitively indicates or expressly informs a user of the grill (or other individuals located in the vicinity of the grill) that the grill is cool enough (e.g., cold enough) to have certain of the grill's exterior surfaces be safely covered by a fabric cover (e.g., a vinyl, polyester, nylon, or canvas cover).

In some examples, a grill is disclosed. In some disclosed examples, the grill comprises a controller to determine whether a condition indicative of a safety-based temperature status of the grill is satisfied. In some disclosed examples, the controller, in response to determining that the condition is satisfied, is to instruct a lighting module or a user interface of the grill to present a notification indicating the safety-based temperature status.

In some disclosed examples, the controller, in response to determining that the condition is satisfied, is to instruct the lighting module to illuminate a light source of the lighting module.

In some disclosed examples, the controller, in response to determining that the condition is satisfied, is to instruct the lighting module to pulse a light source of the lighting module.

In some disclosed examples, the controller, in response to determining that the condition is satisfied, is to instruct the lighting module to cease illuminating a light source of the lighting module.

In some disclosed examples, the lighting module includes a plurality of light sources arranged as a ring, with the ring being concentrically positioned relative to a control knob of the grill.

In some disclosed examples, the lighting module includes a plurality of light sources arranged as a linear series, with the linear series being positioned between a pair of control buttons of the grill.

In some disclosed examples, the controller, in response to determining that the condition is satisfied, is to instruct one or more output devices of the user interface to present the notification textually, graphically, or audibly.

In some disclosed examples, the controller, in response to determining that the condition is satisfied, is to instruct the notification to be presented at a remote device in electrical communication with the grill.

In some disclosed examples, the notification indicates that the grill is warm.

In some disclosed examples, the controller is to determine that the condition is satisfied in response to the controller determining that a temperature of a cooking chamber of the grill is above a temperature threshold.

In some disclosed examples, the controller is to determine that the condition is satisfied in response to the controller determining that a temperature of an external surface of the grill is above a temperature threshold.

In some disclosed examples, the controller is to determine that the condition is satisfied in response to the controller determining that a flame remains present at a burner of the grill over a predetermined duration.

In some disclosed examples, the controller is to determine that the condition is satisfied in response to the controller determining that a burner valve of the grill remains in an open position over a predetermined duration.

In some disclosed examples, the notification indicates that the grill is cool.

In some disclosed examples, the controller is to determine that the condition is satisfied in response to the controller determining that a temperature of a cooking chamber of the grill is below a temperature threshold.

In some disclosed examples, the controller is to determine that the condition is satisfied in response to the controller determining that a temperature of an external surface of the grill is below a temperature threshold.

In some disclosed examples, the controller is to determine that the condition is satisfied in response to the controller determining that a flame remains absent at a burner of the grill over a predetermined duration.

In some disclosed examples, the controller is to determine that the condition is satisfied in response to the controller determining that a burner valve of the grill remains in a closed position over a predetermined duration.

In some examples, a method is disclosed. In some disclosed examples, the method comprises determining, via a controller of a grill, whether a condition indicative of a safety-based temperature status of the grill is satisfied. In some disclosed examples, the method further comprises presenting a notification via a lighting module or a user interface of the grill in response to determining that the condition is satisfied. In some disclosed examples, the notification indicates the safety-based temperature status.

In some disclosed examples, presenting the notification includes illuminating a light source of the lighting module.

In some disclosed examples, presenting the notification includes pulsing a light source of the lighting module.

In some disclosed examples, presenting the notification includes terminating an illumination of a light source of the lighting module.

In some disclosed examples, the lighting module includes a plurality of light sources arranged as a ring, with the ring being concentrically positioned relative to a control knob of the grill.

In some disclosed examples, the lighting module includes a plurality of light sources arranged as a linear series, with the linear series being positioned between a pair of control buttons of the grill.

In some disclosed examples, presenting the notification includes textually, graphically, or audibly presenting the notification via one or more output devices of the user interface.

In some disclosed examples, the method further comprises presenting the notification at a remote device in electrical communication with the grill.

In some disclosed examples, the notification indicates that the grill is warm.

In some disclosed examples, determining that the condition is satisfied includes determining, via the controller, that a temperature of a cooking chamber of the grill is above a temperature threshold.

In some disclosed examples, determining that the condition is satisfied includes determining, via the controller, that a temperature of an external surface of the grill is above a temperature threshold.

In some disclosed examples, determining that the condition is satisfied includes determining, via the controller, that a flame remains present at a burner of the grill over a predetermined duration.

In some disclosed examples, determining that the condition is satisfied includes determining, via the controller, that a burner valve of the grill remains in an open position over a predetermined duration.

In some disclosed examples, the notification indicates that the grill is cool.

In some disclosed examples, determining that the condition is satisfied includes determining, via the controller, that a temperature of a cooking chamber of the grill is below a temperature threshold.

In some disclosed examples, determining that the condition is satisfied includes determining, via the controller, that a temperature of an external surface of the grill is below a temperature threshold.

In some disclosed examples, determining that the condition is satisfied includes determining, via the controller, that a flame remains absent at a burner of the grill over a predetermined duration.

In some disclosed examples, determining that the condition is satisfied includes determining, via the controller, that a burner valve of the grill remains in a closed position over a predetermined duration.

In some examples, a non-transitory computer-readable medium is disclosed. In some disclosed examples, the non-transitory computer-readable medium comprises computer-readable instructions. In some disclosed examples, the computer-readable instructions, when executed, cause one or more processors of a grill to determine whether a condition indicative of a safety-based temperature status of the grill is satisfied. In some disclosed examples, the computer-readable instructions, when executed, cause the one or more processors, in response to determining that the condition is satisfied, to instruct a lighting module or a user interface of the grill to present a notification indicating the safety-based temperature status.

In some disclosed examples, the computer-readable instructions, when executed, cause the one or more processors, in response to determining that the condition is satisfied, to instruct the lighting module to illuminate a light source of the lighting module.

In some disclosed examples, the computer-readable instructions, when executed, cause the one or more processors, in response to determining that the condition is satisfied, to instruct the lighting module to pulse a light source of the lighting module.

In some disclosed examples, the computer-readable instructions, when executed, cause the one or more processors, in response to determining that the condition is satisfied, to instruct the lighting module to cease illuminating a light source of the lighting module.

In some disclosed examples, the computer-readable instructions, when executed, cause the one or more processors, in response to determining that the condition is satisfied, to instruct one or more output devices of the user interface to present the notification textually, graphically, or audibly.

In some disclosed examples, the computer-readable instructions, when executed, cause the one or more processors, in response to determining that the condition is satisfied, to instruct the notification to be presented at a remote device in electrical communication with the grill.

In some disclosed examples, the notification indicates that the grill is warm.

In some disclosed examples, the computer-readable instructions, when executed, cause the one or more processors to determine that the condition is satisfied when the one or more processors determine that a temperature of a cooking chamber of the grill is above a temperature threshold.

In some disclosed examples, the computer-readable instructions, when executed, cause the one or more processors to determine that the condition is satisfied when the one or more processors determine that a temperature of an external surface of the grill is above a temperature threshold.

In some disclosed examples, the computer-readable instructions, when executed, cause the one or more processors to determine that the condition is satisfied when the one or more processors determine that a flame remains present at a burner of the grill over a predetermined duration.

In some disclosed examples, the computer-readable instructions, when executed, cause the one or more processors to determine that the condition is satisfied when the one or more processors determine that a burner valve of the grill remains in an open position over a predetermined duration.

In some disclosed examples, the notification indicates that the grill is cool.

In some disclosed examples, the computer-readable instructions, when executed, cause the one or more processors to determine that the condition is satisfied when the one or more processors determine that a temperature of a cooking chamber of the grill is below a temperature threshold.

In some disclosed examples, the computer-readable instructions, when executed, cause the one or more processors to determine that the condition is satisfied when the one or more processors determine that a temperature of an external surface of the grill is below a temperature threshold.

In some disclosed examples, the computer-readable instructions, when executed, cause the one or more processors to determine that the condition is satisfied when the one or more processors determine that a flame remains absent at a burner of the grill over a predetermined duration.

In some disclosed examples, the computer-readable instructions, when executed, cause the one or more processors to determine that the condition is satisfied when the one or more processors determine that a burner valve of the grill remains in a closed position over a predetermined duration.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. A grill, comprising:
a controller to:
determine whether a condition indicative of a safety-based temperature status of the grill is satisfied; and
in response to determining that the condition is satisfied, instruct a lighting module or a user interface of the grill to present a notification indicating the safety-based temperature status.

2. The grill of claim 1, wherein the controller, in response to determining that the condition is satisfied, is to instruct the lighting module to illuminate a light source of the lighting module.

3. The grill of claim 1, wherein the controller, in response to determining that the condition is satisfied, is to instruct the lighting module to pulse a light source of the lighting module.

4. The grill of claim 1, wherein the controller, in response to determining that the condition is satisfied, is to instruct the lighting module to cease illuminating a light source of the lighting module.

5. The grill of claim 1, wherein the lighting module includes a plurality of light sources arranged as a ring, the ring concentrically positioned relative to a control knob of the grill.

6. The grill of claim 1, wherein the lighting module includes a plurality of light sources arranged as a linear series, the linear series positioned between a pair of control buttons of the grill.

7. The grill of claim 1, wherein the controller, in response to determining that the condition is satisfied, is to instruct one or more output devices of the user interface to present the notification textually, graphically, or audibly.

8. The grill of claim 1, wherein the controller, in response to determining that the condition is satisfied, is to instruct the notification to be presented at a remote device in electrical communication with the grill.

9. The grill of claim 1, wherein the notification indicates that the grill is warm.

10. The grill of claim 9, wherein the controller is to determine that the condition is satisfied in response to the controller determining that a temperature of a cooking chamber of the grill is above a temperature threshold.

11. The grill of claim 9, wherein the controller is to determine that the condition is satisfied in response to the controller determining that a temperature of an external surface of the grill is above a temperature threshold.

12. The grill of claim 9, wherein the controller is to determine that the condition is satisfied in response to the controller determining that a flame remains present at a burner of the grill over a predetermined duration.

13. The grill of claim 9, wherein the controller is to determine that the condition is satisfied in response to the controller determining that a burner valve of the grill remains in an open position over a predetermined duration.

14. The grill of claim 1, wherein the notification indicates that the grill is cool.

15. The grill of claim 14, wherein the controller is to determine that the condition is satisfied in response to the controller determining that a temperature of a cooking chamber of the grill is below a temperature threshold.

16. The grill of claim 14, wherein the controller is to determine that the condition is satisfied in response to the controller determining that a temperature of an external surface of the grill is below a temperature threshold.

17. The grill of claim 14, wherein the controller is to determine that the condition is satisfied in response to the controller determining that a flame remains absent at a burner of the grill over a predetermined duration.

18. The grill of claim 14, wherein the controller is to determine that the condition is satisfied in response to the controller determining that a burner valve of the grill remains in a closed position over a predetermined duration.

19. A method, comprising:
determining, via a controller of a grill, whether a condition indicative of a safety-based temperature status of the grill is satisfied; and
presenting a notification via a lighting module or a user interface of the grill in response to determining that the condition is satisfied, the notification indicating the safety-based temperature status.

20-36. (canceled)

37. A non-transitory computer-readable medium comprising computer-readable instructions that, when executed, cause one or more processors of a grill to at least:
determine whether a condition indicative of a safety-based temperature status of the grill is satisfied; and
in response to determining that the condition is satisfied, instruct a lighting module or a user interface of the grill to present a notification indicating the safety-based temperature status.

38-52. (canceled)
